(19) United States
(12) Patent Application Publication
(10) Pub. No.: US 2023/0104971 A1
(43) Pub. Date: Apr. 6, 2023

(54) ELECTROSTATIC CHARGE IMAGE DEVELOPING TONER SET, ELECTROSTATIC CHARGE IMAGE DEVELOPER SET, AND TONER CARTRIDGE SET

(71) Applicant: FUJIFILM Business Innovation Corp., Tokyo (JP)

(72) Inventors: Ryutaro KEMBO, Kanagawa (JP); Yukiaki NAKAMURA, Kanagawa (JP); Tomoaki TANAKA, Kanagawa (JP)

(73) Assignee: FUJIFILM Business Innovation Corp., Tokyo (JP)

(21) Appl. No.: 17/586,713

(22) Filed: Jan. 27, 2022

(30) Foreign Application Priority Data
Sep. 22, 2021 (JP) 2021-154743

(51) Int. Cl. G03G 9/09; G03G 9/087; G03G 9/08; C09B 57/00; C09B 47/08; G03G 15/08

(52) U.S. Cl. CPC G03G 9/0924; G03G 9/0902; G03G 9/08711; G03G 9/08755; G03G 9/0918; G03G 9/0821; G03G 9/0926; C09B 57/00; C09B 47/08; G03G 15/0865

(57) ABSTRACT

An electrostatic charge image developing toner set includes a toner A that contains a binder resin A and a dye, and a white toner B that contains a binder resin B and a titanium oxide pigment, in which an absolute value of a difference (ΔSP value) in solubility parameter between the binder resin A contained in the toner A and the binder resin B contained in the white toner B is 0.5 or greater.

### CROSS-REFERENCE TO RELATED APPLICATIONS

This application is based on and claims priority under 35 USC 119 from Japanese Patent Application No. 2021-154743 filed Sep. 22, 2021.

### BACKGROUND

### (i) Technical Field

The present invention relates to an electrostatic charge image developing toner set, an electrostatic charge image developer set, and a toner cartridge set.

### (ii) Related Art

Methods of visualizing image information, such as electrophotographic methods, are currently used in various fields. In the electrophotographic methods, an electrostatic charge image is formed as image information on a surface of an image holding member by charging the surface thereof and forming an electrostatic charge image. Further, a toner image is formed on the surface of the image holding member using a developer containing a toner, the toner image is transferred to a recording medium, and the toner image is fixed to the recording medium. The image information is visualized as an image by performing such steps.

For example, JP2007-140230A discloses an electrostatic charge image developing toner containing toner particles formed by dispersing, in a binder resin for forming toner particles, colored fine particles having an average primary particle diameter of 10 to 300 nm, which contain a dye and a medium resin for colored fine particles that is different from the binder resin for forming toner particles.

Further, JP2002-116631A discloses an image forming device that transfers and fixes a toner image formed on an image forming member onto a transfer material, in which image formation is performed using a non-glossy dark toner and a glossy light toner.

Further, JP2021-110802A describes an electrophotographic image forming method using a white toner and a chromatic toner containing a cyan toner, in which the white toner contains titanium oxide as a colorant, the cyan toner contains a phthalocyanine compound represented by Chemical Formula 1 as the main component of the colorant.

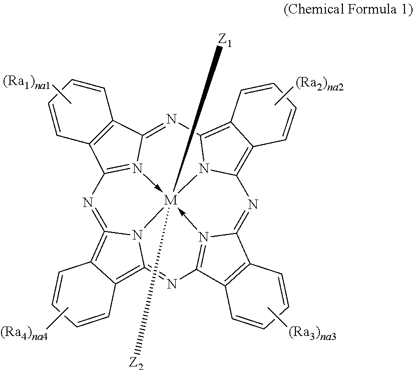

In Chemical Formula 1, M represents a silicon atom, a germanium atom, or a tin atom, Ra₁ to Ra₄ each independently represent an electron-withdrawing substituent, na1 to na4 each independently an integer of 0 to 4, and Z₁ and Z₂ each independently represent a hydroxy group, an aryloxy group having 6 to 18 carbon atoms, an alkoxy group having 1 to 22 carbon atoms, or a group represented by Chemical Formula 2.

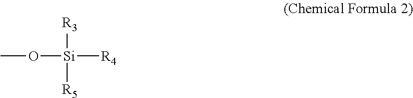

In Chemical Formula 2, R₃ to R₅ each independently represent an alkyl group having 1 to 6 carbon atoms, an aryl group having 6 to 18 carbon atoms, or an alkoxy group having 1 to 6 carbon atoms, and in a case where the average dispersion diameter of the colorant in the white toner is defined as Dw and the average dispersion diameter of the phthalocyanine compound in the cyan toner is defined as Dc, Dw and Dc satisfy Mathematical Formula 1 and Mathematical Formula 2.

100 nm≤Dw≤1500 nm Mathematical Formula 1

50 nm≤Dc≤800 nm Mathematical Formula 2

### SUMMARY

Aspects of non-limiting embodiments of the present disclosure relate to an electrostatic charge image developing toner set, an electrostatic charge image developer set, and a toner cartridge set that capable of obtaining an image with an excellent property of suppressing fading in a high-temperature and high-humidity environment, as compared to a case where an absolute value of a difference (ΔSP value) in solubility parameter (SP value) between a binder resin A contained in a toner A and a binder resin B contained in a white toner B is less than 0.5, and both the binder resin A contained in the toner A and the binder resin B contained in the white toner B are styrene acrylic resins or polyester resins.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Means for solving the above-described problem includes the following aspects.

According to an aspect of the present disclosure, there is provided an electrostatic charge image developing toner set including a toner A that contains a binder resin A and a dye, and a white toner B that contains a binder resin B and a titanium oxide pigment, in which an absolute value of a difference (ΔSP value) in solubility parameter between the binder resin A contained in the toner A and the binder resin B contained in the white toner B is 0.5 or greater.

### BRIEF DESCRIPTION OF THE DRAWINGS

Exemplary embodiment(s) of the present invention will be described in detail based on the following figures, wherein:

FIG. 1 is a schematic configuration view showing an example of an image forming device according to the present exemplary embodiment; and

FIG. 2 is a schematic configuration view showing an example of a process cartridge according to the present exemplary embodiment.

### DETAILED DESCRIPTION

Hereinafter, exemplary embodiments that are examples of the present invention will be described.

In a numerical range described in a stepwise manner, an upper limit or a lower limit described in a certain numerical range may be replaced with an upper limit or a lower limit in another numerical range described in a stepwise manner.

Further, in a numerical range, an upper limit or a lower limit described in a certain numerical range may be replaced with a value shown in an example.

In a case where a plurality of kinds of substances corresponding to each component in a composition are present, the amount of each component in the composition indicates the total amount of the plurality of kinds of substances present in the composition unless otherwise specified.

In the present disclosure, the meaning of the term “step” includes not only an independent step but also a step whose intended purpose is achieved even in a case where the step is not clearly distinguished from other steps.

### Electrostatic Charge Image Developing Toner

According to a first embodiment of an electrostatic charge image developing toner set according to the present exemplary embodiment, the electrostatic charge image developing toner set includes a toner A that contains a binder resin A and a dye, and a white toner B that contains a binder resin B and a titanium oxide pigment, in which the absolute value of a difference (ΔSP value) in solubility parameter between the binder resin A contained in the toner A and the binder resin B contained in the white toner B is 0.5 or greater.

According to a second embodiment of an electrostatic charge image developing toner set according to the present exemplary embodiment, the electrostatic charge image developing toner set includes a toner A that contains a binder resin A and a dye, and a white toner B that contains a binder resin B and a titanium oxide pigment, in which one of the binder resin A contained in the toner A or the binder resin B contained in the white toner B contains a styrene acrylic resin, and the other contains a polyester resin.

In the present specification, unless otherwise specified, the expression of simply the “electrostatic charge image developing toner set according to the present exemplary embodiment” or simply the “toner set” corresponds to the description in the first and second exemplary embodiments. Further, unless otherwise specified, the simple expression of the “dye” or the like corresponds to the description of the dye or the like in the first exemplary embodiment and the second exemplary embodiment.

Examples of the toner A in the electrostatic charge image developing toner set according to the present exemplary embodiment include a yellow toner, a cyan toner, a magenta toner, a black toner, a red toner, green toner, a blue toner, an orange toner, and a violet toner.

Further, the toner A and the white toner B in the electrostatic charge image developing toner set according to the present exemplary embodiment may be fluorescent color toners.

In the electrostatic charge image developing toner set according to the present exemplary embodiment, the toner A and the white toner B may be respectively used alone or in combination of two or more kinds thereof.

The electrostatic charge image developing toner set according to the present exemplary embodiment may contain other toners.

Among other toners, from the viewpoint of easily forming a full-color image, the electrostatic charge image developing toner set according to the present exemplary embodiment contains, for example, preferably a yellow toner, a cyan toner, and a magenta toner as the toner A and more preferably a yellow toner, a cyan toner, a magenta toner, and a black toner.

Further, the toner of each color used in the present exemplary embodiment may be toner particles containing no external additive or may be toner particles to which an external additive has been externally added.

In a case where the binder resin A used in the toner A containing a dye and the binder resin B used in the white toner B are easily compatible with each other, respective toner particles of the toner A and the white toner B are mixed with each other from the vicinity of each surface of the toner particle in a case where the toner A and the white toner B are heated and melted in the fixing step. At this time point, the dye present in the vicinity of the surface of the toner particle of the toner A comes into contact with the titanium oxide pigment present in the vicinity of the surface of the toner particle of the white toner B. Further, in a case where the fixed image is stored in a high-temperature environment (for example, in a place exposed to direct sunlight/on an electronic device or metal with heat), the temperature is locally increased to a temperature higher than or equal to the glass transition temperature (Tg) of the binder resin so that the molecular mobility increases, and the dye may move in the toner in association with the increased molecular mobility, but as described above, the interface between the toner A and the white toner B may not be present in a case where the vicinity of the surface of the toner A and the vicinity of the surface of the white toner B are compatible with each other due to the heat during the fixation as described above. Therefore, it is considered that the dye reaches the inside of the toner image of the white toner B, comes into contact with titanium oxide (radicals generated from the toner B) in the toner B, is decomposed, and fades. Further, it is considered that since the photocatalytic action of the titanium oxide pigment is likely to proceed when exposed to direct sunlight, and the amount of superoxide anion radicals and hydroxide radicals to be generated increases, fading is likely to further proceed.

In addition, the reaction between positive holes generated by the catalytic action of the titanium oxide pigment and oxygen in air is likely to proceed in a high-humidity environment, and thus an increase in the amount of hydroxide radicals to be generated is also considered to promote fading in the image.

In the electrostatic charge image developing toner set according to the present exemplary embodiment, it is considered that the compatibility between the toner A and the white toner B can be controlled and the interface between the toner A and the white toner B can be maintained even after being heated in the fixing step can be maintained in a case where the absolute value of the difference (ΔSP value) in solubility parameter between the binder resin A contained in the toner A and the binder resin B contained in the white toner B is 0.5 or greater or in a case where one of the binder resin A contained in the toner A or the binder resin B contained in the white toner B contains a styrene acrylic resin and the other contains a polyester resin. In this manner, it is assumed that the dye does not enter the region of the binder resin B of the white toner, decomposition due to the contact with the titanium oxide pigment is prevented, and thus fading can be suppressed.

### Absolute Value of Difference (ΔSP value) in Solubility Parameter Between Binder Resin A Contained in Toner A and Binder Resin B Contained in White Toner B

In the first exemplary embodiment of the electrostatic charge image developing toner set according to the present exemplary embodiment, the absolute value of the difference (ΔSP value) in solubility parameter between the binder resin A contained in the toner A and the binder resin B contained in the white toner B is 0.5 or greater, and from the viewpoint of obtaining an image with an excellent property of suppressing fading in a high-temperature and high-humidity environment (hereinafter, also simply referred to as “from the viewpoint of the property of suppressing fading in a high-temperature and high-humidity environment”), for example, is preferably 0.7 or greater, more preferably 1.0 or greater, and particularly preferably 1.2 or greater. Further, from the viewpoint of reproducibility of the target color (the property of suppressing deviation of dots of a color toner containing a dye from the target) in a halftone image of white and color superposition, for example, the absolute value is preferably 3.0 or less.

In the second exemplary embodiment of the electrostatic charge image developing toner set according to the present exemplary embodiment, from the viewpoint of the property of suppressing fading in a high-temperature and high-humidity environment, the absolute value of the difference (ΔSP value) in solubility parameter between the binder resin A contained in the toner A and the binder resin B contained in the white toner B is, for example, preferably 0.5 or greater, more preferably 0.7 or greater, still more preferably 1.0 or greater, and particularly preferably 1.2 or greater. Further, from the viewpoint of reproducibility of the target color (the property of suppressing deviation of dots of a color toner containing a dye from the target) in a halftone image of white and color superposition, for example, the absolute value is preferably 3.0 or less.

In the present exemplary embodiment, the “solubility parameter (SP value)” is a value calculated by the Fedor's method. Specifically, the solubility parameter (SP value) is, for example, in conformity with the description in Polym. Eng. Sci., vol. 14, p. 147 (1974), and the SP value is calculated by the following equation.

SP value=√(Ev/v)=√(ΣΔei/ΣΔvi) Equation:

(In the equation, Ev: evaporation energy (cal/mol), v: molar volume (cm³/mol), Δei: evaporation energy of each atom or atomic group, and Δvi: molar volume of each atom or atomic group)

Further, the solubility parameter (SP value) is denoted by units of (cal/cm³)^{1/2}, but the units are omitted according to the practice and the solubility parameter is expressed dimensionlessly.

### Relationship Between Binder Resin A Contained in Toner A and Binder Resin B Contained in White Toner B in Terms of Resin Type

In the second exemplary embodiment of the electrostatic charge image developing toner set according to the present exemplary embodiment, one of the binder resin A contained in the toner A or the binder resin B contained in the white toner B contains a styrene acrylic resin and the other contains a polyester resin, and from the viewpoint of the property of suppressing fading in a high-temperature and high-humidity environment, for example, it is preferable that the binder resin A is a styrene acrylic resin and the binder resin B is a polyester resin.

In the first exemplary embodiment of the electrostatic charge image developing toner set according to the present exemplary embodiment, from the viewpoint of the property of suppressing fading in a high-temperature and high-humidity environment, for example, it is preferable that one of the binder resin A contained in the toner A or the binder resin B contained in the white toner B contains a styrene acrylic resin and the other contains a polyester resin and more preferable that the binder resin A is a styrene acrylic resin and the binder resin B is a polyester resin.

### Type of Dye Contained in Toner A

Further, in the electrostatic charge image developing toner set according to the present exemplary embodiment, from the viewpoint of the property of suppressing fading in a high-temperature and high-humidity environment, for example, the dye contains preferably at least one of a pyrazolotriazole-based dye or a phthalocyanine-based dye and more preferably at least one of a pyrazolotriazole-based compound represented by Formula (I) or a phthalocyanine-based compound represented by Formula (II).

Further, in the electrostatic charge image developing toner set according to the present exemplary embodiment, from the viewpoint of the property of suppressing fading in a high-temperature and high-humidity environment, for example, it is preferable that the content of the binder resin A is 51% by mass or greater with respect to the total mass of the binder resin contained in the toner A and the content of the binder resin B is 51% by mass or greater with respect to the total mass of the binder resin contained in the white toner B, more preferable that the content of the binder resin A is 80% by mass or greater with respect to the total mass of the binder resin contained in the toner A and the content of the binder resin B is 80% by mass or greater with respect to the total mass of the binder resin contained in the white toner B, and particularly preferable that the content of the binder resin A is 95% by mass or greater and 100% by mass or less with respect to the total mass of the binder resin contained in the toner A and the content of the binder resin B is 95% by mass or greater and 100% by mass or less with respect to the total mass of the binder resin contained in the white toner B. Further, the binder resin A may consist of a plurality of resins as in an example of “styrene acrylic resin A=styrene acrylic resin A1+styrene acrylic resin A2”. In such a case, as the solubility parameter (SP value), a value in a case where the styrene acrylic resin A1 and the styrene acrylic resin A2 are mixed according to the compositional ratio is defined as the SP value (SPA) of the binder resin A.

Similarly, the binder resin B may consist of a plurality of resins as in an example of “polyester resin B=polyester resin B1+polyester resin B2”. In such a case, as the solubility parameter (SP value), a value in a case where the polyester resin B1 and the polyester resin B2 are mixed according to the compositional ratio is defined as the SP value (SPB) of the binder resin B.

### Toner A and White Toner B

The electrostatic charge image developing toner set according to the present exemplary embodiment contains a toner A containing a dye and a white toner B containing a titanium oxide pigment.

Further, for example, it is preferable that the toner A and the white toner B each independently contain a binder resin. Further, the toner A and the white toner B may each independently contain a release agent and other additives.

Further, the toner A and the white toner B may each independently be toners with an external additive, in which an external additive is externally added to the toner particles.

### Dye

The toner A contains a dye.

As the dye, known dyes are used, and examples thereof include various dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye in addition to a pyrazolotriazole-based dye and a phthalocyanine-based dye.

In the present exemplary embodiment, the “pigment” is a colorant in which the solubility in 100 g of water at 23° C. and the solubility in 100 g of cyclohexanone at 23° C. are respectively less than 0.1 g, and the “dye” is a colorant in which the solubility in 100 g of water at 23° C. or the solubility in 100 g of cyclohexanone at 23° C. is 0.1 g or greater.

Examples of the dye include a pyrazolotriazole-based compound represented by Formula (I).

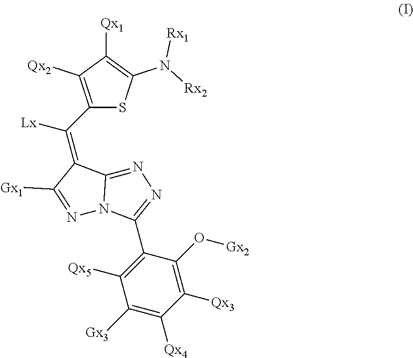

In Formula (I), Rx₁ and Rx₂ each independently represent an alkyl group which may have a substituent, Lx represents a hydrogen atom or an alkyl group which may have a substituent, Gx₁ represents an alkyl group having 2 or more carbon atoms, Gx₂ represents an aryl group or an alkyl group which may have a substituent, Gx₃ represents a hydrogen atom, a halogen atom, Gx₄—CO—NH—, or Gx₅—N (Gx₆)—CO—, Gx₄ represents an aryl group or an alkyl group which may have a substituent, Gx₅ and Gx₆ each independently represent a hydrogen atom or an alkyl group which may have a substituent, and Qx₁ to Qx₅ each independently represent a hydrogen atom, a halogen atom, or an alkyl group which may have a substituent.

### Rx₁ and Rx₂

Rx₁ and Rx₂, for example, each independently represent an alkyl group which may have a substituent and preferably an alkyl group. Here, the alkyl group which may have a substituent includes not only an alkyl group (a substituent consisting of only an alkyl group) but also a substituent in which one or more atoms constituting an alkyl group are substituted with a substituent (for example, an alkenyl group) other than an alkyl group.

The alkyl group may be any of a linear alkyl group, a branched alkyl group, or a cycloalkyl group, but is, for example, preferably a linear alkyl group or a branched alkyl group.

Examples of the linear alkyl group include a methyl group, an ethyl group, a propyl group, an n-butyl group, a pentyl group, a hexyl group, an octyl group, a dodecyl group, a tridecyl group, a tetradecyl group, and a pentadecyl group.

Examples of the branched alkyl group include an isopropyl group, an isobutyl group, a tert-butyl group, an amyl group, and an isoamyl group.

Examples of the cycloalkyl group include a cyclopropyl group, a cyclobutyl group, a cyclopentyl group, a cyclohexyl group, and a 4-tert-butyl-cyclohexyl group.

The total number of carbon atoms contained in the alkyl group represented by Rx₁ and carbon atoms contained in the alkyl group represented by Rx₂ is, for example, preferably 8 or greater, more preferably 12 or greater, and still more preferably 16 or greater.

Examples of the substituent in the alkyl group which may have a substituent include an alkenyl group, an alkynyl group, an aryl group, an aliphatic heterocyclic group, an aromatic heterocyclic group, an alkoxy group, a cycloalkoxy group, an aryloxy group, an alkylthio group, a cycloalkylthio group, an arylthio group, an alkoxycarbonyl group, an aryloxycarbonyl group, a phosphoryl group, a sulfamoyl group, an acyl group, an acyloxy group, an amide group, a carbamoyl group, a ureido group, a sulfinyl group, an alkylsulfonyl group, an arylsulfonyl group, and an amino group. That is, Rx₁ and Rx₂ may each independently be formed such that one or more atoms constituting the alkyl group are substituted with any of such substituents. The number of substituents with which one or more atoms constituting the alkyl group are substituted is not limited to one, and may be two or greater.

Examples of the alkenyl group include a vinyl group and an allyl group.

Examples of the alkynyl group include an ethynyl group and a propargyl group.

Examples of the aryl group include a phenyl group and a naphthyl group.

Examples of the aliphatic heterocyclic group include a pyrrolidyl group, an imidazolidyl group, a morphoryl group, and an oxazolidyl group.

Examples of the aromatic heterocyclic group includes a furyl group, a thienyl group, a pyridyl group, a pyridazyl group, a pyrimidyl group, a pyrazyl group, a triazyl group, an imidazolyl group, a pyrazolyl group, a thiazolyl group, a benzimidazolyl group, a benzoxazolyl group, a quinazolyl group, and a phthalazyl group.

Examples of the alkoxy group include a methoxy group, an ethoxy group, a propyloxy group, a pentyloxy group, a hexyloxy group, an octyloxy group, and a dodecyloxy group.

Examples of the cycloalkoxy group include a cyclopentyloxy group and a cyclohexyloxy group.

Examples of the aryloxy group include a phenoxy group and a naphthyloxy group.

Examples of the alkylthio group include a methylthio group, an ethylthio group, a propylthio group, a pentylthio group, a hexylthio group, an octylthio group, and a dodecylthio group.

Examples of the cycloalkylthio group include a cyclopentylthio group and a cyclohexylthio group.

Examples of the arylthio group include a phenylthio group and a naphthylthio group.

Examples of the alkoxycarbonyl group include a methyloxycarbonyl group, an ethyloxycarbonyl group, a butyloxycarbonyl group, an octyloxycarbonyl group, and a dodecyloxycarbonyl group.

Examples of the aryloxycarbonyl group include a phenyloxycarbonyl group and a naphthyloxycarbonyl group.

Examples of the phosphoryl group include a methoxyphosphoryl group and a diphenylphosphoryl group.

Examples of the sulfamoyl group includes an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group, and a 2-pyridylaminosulfonyl group.

Examples of the acyl group include an acetyl group, an ethylcarbonyl group, a propylcarbonyl group, a pentylcarbonyl group, a cyclohexylcarbonyl group, an octylcarbonyl group, a 2-ethylhexylcarbonyl group, a dodecylcarbonyl group, a phenylcarbonyl group, a naphthylcarbonyl group, and a pyridylcarbonyl group.

Examples of the acyloxy group include an acetyloxy group, an ethylcarbonyloxy group, a butylcarbonyloxy group, an octylcarbonyloxy group, a dodecylcarbonyloxy group, and a phenylcarbonyloxy group.

Examples of the amide group include a methylcarbonylamino group, an ethylcarbonylamino group, a dimethylcarbonylamino group, a propylcarbonylamino group, a pentylcarbonylamino group, a cyclohexylcarbonylamino group, a 2-ethylhexylcarbonylamino group, an octylcarbonylamino group, a dodecylcarbonylamino group, a phenylcarbonylamino group, and a naphthylcarbonylamino group.

Examples of the carbamoyl group includes an aminocarbonyl group, a methylaminocarbonyl group, a dimethylaminocarbonyl group, a propylaminocarbonyl group, a pentylaminocarbonyl group, a cyclohexylaminocarbonyl group, an octylaminocarbonyl group, a 2-ethylhexylaminocarbonyl group, a dodecylaminocarbonyl group, a phenylaminocarbonyl group, a naphthylaminocarbonyl group, and a 2-pyridylaminocarbonyl group.

Examples of the ureido group include a methylureido group, an ethylureido group, a pentylureido group, a cyclohexylureido group, an octylureido group, a dodecylureido group, a phenylureido group, a naphthylureido group, and a 2-pyridylaminoureido group.

Examples of the sulfinyl group include a methylsulfinyl group, an ethylsulfinyl group, a butylsulfinyl group, a cyclohexylsulfinyl group, a 2-ethylhexylsulfinyl group, a dodecylsulfinyl group, a phenylsulfinyl group, a naphthylsulfinyl group, and a 2-pyridylsulfinyl group.

Examples of the alkylsulfonyl group include a methylsulfonyl group, an ethylsulfonyl group, a butylsulfonyl group, a cyclohexylsulfonyl group, a 2-ethylhexylsulfonyl group, and a dodecylsulfonyl group.

Examples of the arylsulfonyl group include a phenylsulfonyl group, a naphthylsulfonyl group, and a 2-pyridylsulfonyl group.

Examples of the amino groups include an amino group, an ethylamino group, a dimethylamino group, a butylamino group, a dibutylamino group, a cyclopentylamino group, a 2-ethylhexylamino group, a dodecylamino group, an anilino group, a naphthylamino group, and a 2-pyridylamino group.

Further, the substituent in the alkyl group which may have a substituent may be an azo group such as a phenylazo group, an alkylsulfonyloxy group such as a methanesulfonyloxy group, a cyano group, a nitro group, a halogen atom (such as a fluorine atom, a chlorine atom, or a bromine atom, the same applies hereinafter) or a hydroxyl group in addition to the substituents described above.

The substituent in the alkyl group which may have a substituent may be any of the above-described substituents, but is, for example, preferably an alkoxy group, an aryl group, a cycloalkoxy group, a halogen atom, or a hydroxyl group.

A substituent other than the above-described substituent may be bonded to the substituent in the alkyl group which may have a substituent.

### Lx

Lx may represent, for example, a hydrogen atom or an alkyl group which may have a substituent and preferably a hydrogen atom. In a case where Lx represents an alkyl group which may have a substituent, Lx may represent any substituent represented by Rx₁ and Rx₂, for example, preferably an alkyl group having 1 to 5 carbon atoms, but is more preferably a methyl group or an ethyl group.

### Gx₁

Gx₁ represents an alkyl group having 2 or more carbon atoms. The alkyl group may be a linear alkyl group, a branched alkyl group, or a cycloalkyl group, but is, for example, preferably a branched alkyl group, more preferably a tertiary alkyl group, and still more preferably a tert-butyl group.

Examples of the linear alkyl group include an ethyl group, a propyl group, an n-butyl group, a pentyl group, a hexyl group, an octyl group, a dodecyl group, a tridecyl group, a tetradecyl group, and a pentadecyl group.

Examples of the branched alkyl group include an isopropyl group, an isobutyl group, a tert-butyl group, an amyl group, and an isoamyl group.

Examples of the cycloalkyl group include a cyclopropyl group, a cyclobutyl group, a cyclopentyl group, a cyclohexyl group, and a 4-tert-butyl-cyclohexyl group.

### Gx₂

Gx₂ may represent an aryl group or an alkyl group which may have a substituent. Here, the aryl group is, for example, a phenyl group or a naphthyl group. Further, the alkyl group which may have a substituent is any substituent represented by Rx₁ and Rx₂. Among the examples, Gx₂ represents, for example, preferably an alkyl group, more preferably an alkyl group having 1 to 5 carbon atoms, and still more preferably a methyl group or an ethyl group.

### Gx₃

Gx₃ represents any of a hydrogen atom, a halogen atom, Gx₄—CO—NH—, or Gx₅—N(Gx₆)—CO—. Among the examples, for example, a hydrogen atom is preferable.

### Gx₄

Gx₄ may represent an aryl group or an alkyl group which may have a substituent. Here, the aryl group is, for example, a phenyl group or a naphthyl group. Further, the alkyl group which may have a substituent is any substituent represented by Rx₁ and Rx₂ and, for example, preferably an alkyl group represented by Rx₁ and Rx₂.

### Gx₅ and Gx₆

Gx₅ and Gx₆ may each independently represent a hydrogen atom or an alkyl group which may have a substituent. Here, the alkyl group which may have a substituent is any substituent represented by Rx₁ and Rx₂ and, for example, preferably an alkyl group represented by Rx₁ and Rx₂.

### Qx₁ to Qx₅

Qx₁ to Qx₅ may each independently represent a hydrogen atom, a halogen atom, or an alkyl group which may have a substituent. Here, the alkyl group which may have a substituent is any substituent represented by Rx₁ and Rx₂. For example, it is preferable that Qx₁ to Qx₅ each independently represent any of a hydrogen atom, an alkyl group, a halogen atom, or an alkoxy group. For example, it is more preferable that all Qx₁ to Qx₅ represent a hydrogen atom.

Specific examples of the pyrazolotriazole-based compound represented by Formula (I) include compounds represented by Formulae (I-1) to (I-23) shown below, but it goes without saying that the compounds are not limited to the specific examples shown below.

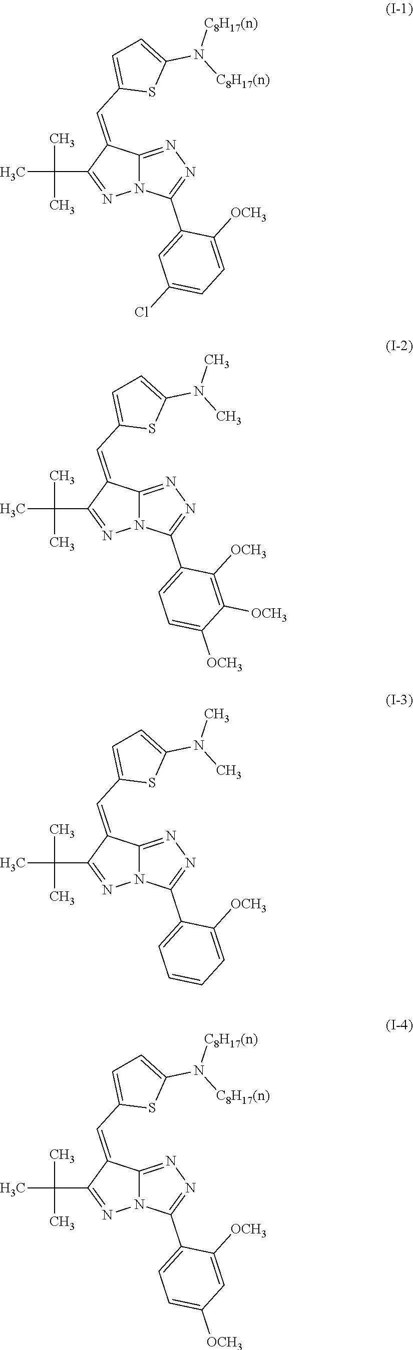

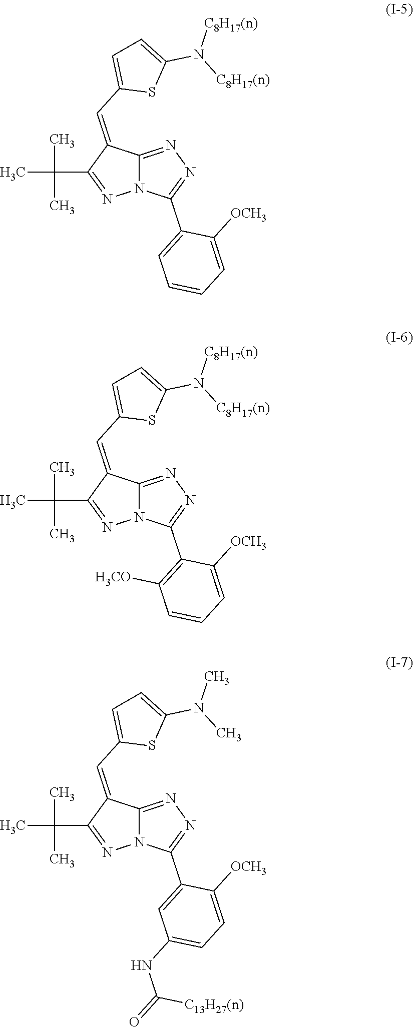

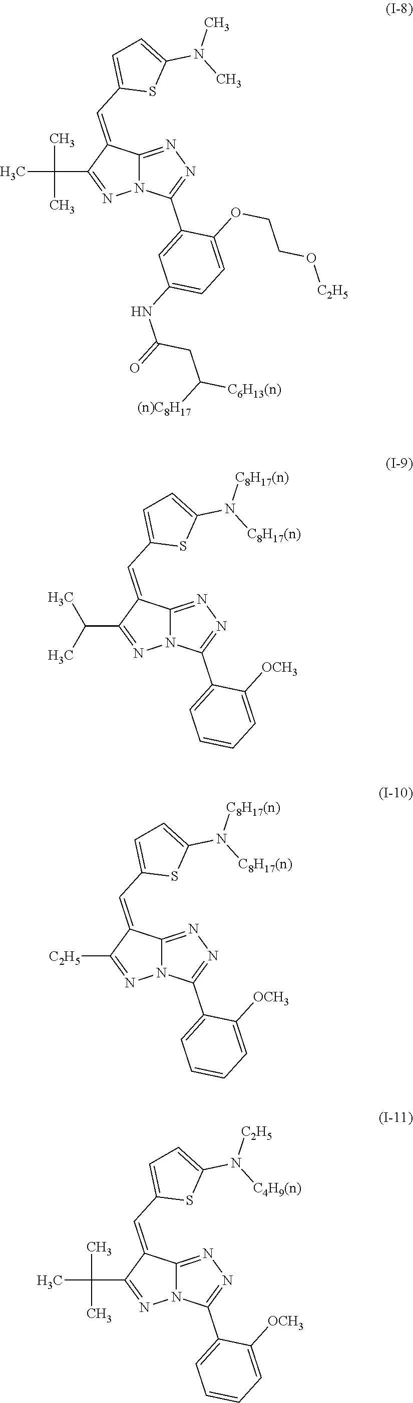

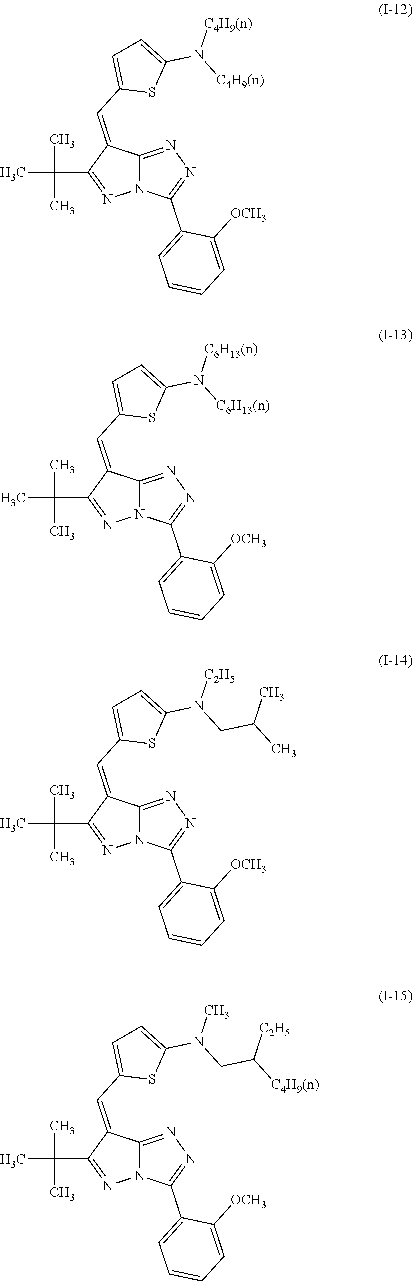

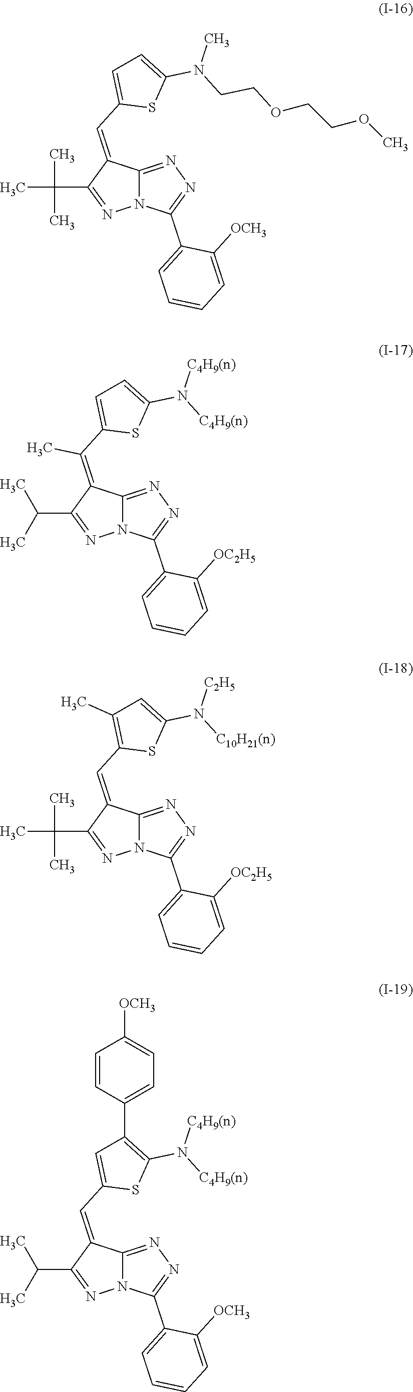

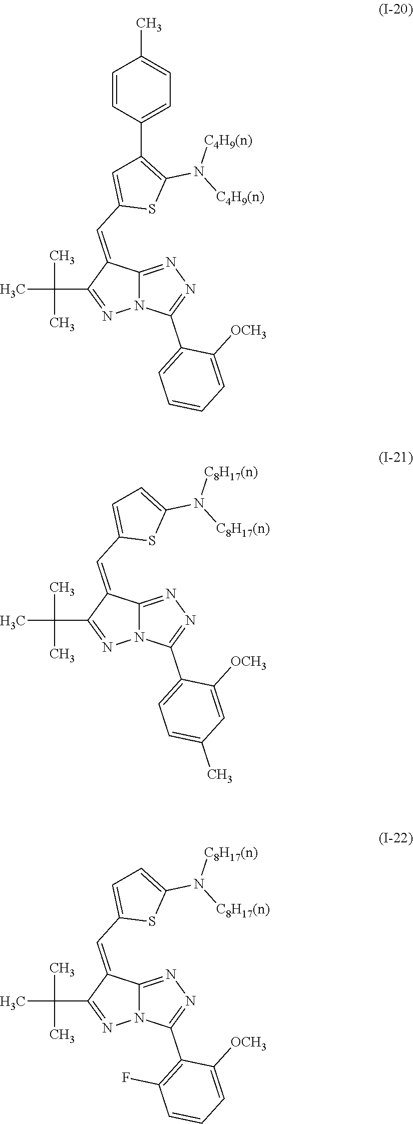

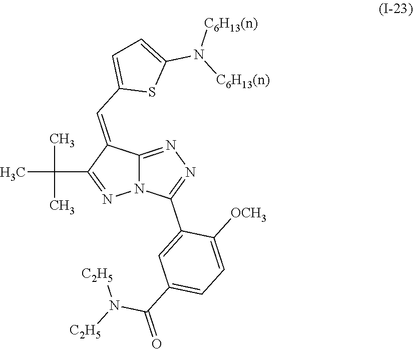

The pyrazolotriazole-based compound represented by Formula (I) may be used alone or in combination of two or more kinds thereof.

Examples of the dye include a phthalocyanine-based compound represented by Formula (II).

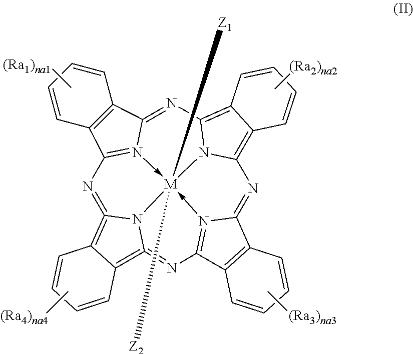

In Formula (II), M represents a silicon atom, a germanium atom, or a tin atom, Ra₁ to Ra₄ each independently represent an electron-withdrawing group, na1 to na4 each independently represent an integer of 0 to 4, and Z₁ and Z₂ each independently represent a hydroxy group, an aryloxy group having 6 to 18 carbon atoms, an alkoxy group having 1 to 22 carbon atoms, or a group represented by Formula (III).

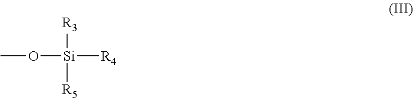

In Formula (III), R₃ to R₅ each independently represent an alkyl group having 1 to 6 carbon atoms, an aryl group having 6 to 18 carbon atoms, or an alkoxy group having 1 to 6 carbon atoms.

The phthalocyanine compound represented by Formula (II) has axial ligands (Z₁ and Z₂) having a bulky structure. Since the phthalocyanine compound has such axial ligands having a bulky structure, the phthalocyanine compound is more likely to be uniformly dispersed in the toner particles and in the fixed image, and the color developability of the cyan toner is further enhanced. Further, even in the superimposed image with the white toner serving as the lowermost layer, since the bulky phthalocyanine compound is unlikely to move, the color mixing between the cyan toner and the white toner is unlikely to occur. Therefore, the color turbidity can be suppressed, and thus excellent color developability can be realized.

In Formula (II), M represents a silicon atom (Si), a germanium atom (Ge), or a tin atom (Sn). From the viewpoint of suppressing color mixing with the white toner using the bulky structure and from the viewpoint of excellent color developability of the compound, it is preferable that M represents, for example, a silicon atom (Si).

In Formula (II), Ra₁ to Ra₄ (Ra₁, Ra₂, Ra₃, and Ra₄) each independently represent an electron-withdrawing group. Examples of the electron-withdrawing group include a chloro group (—Cl), a monochlorodihalogenomethyl group (—CClX₂), a trifluoromethyl group (—CF₃) , and a nitro group (—NO₂). In addition, “X” in the monochlorodihalogenomethyl group (—CClX₂) represents a halogen atom.

In Formula (II), na1 to na4 (na1, na2, na3, and na4) each independently represent an integer of 0 to 4. In a case where na1 to na4 represent an integer of 0 to 4, a desired color gamut can be covered as a colorant.

In Formula (II), Z₁ and Z₂ each independently represent a hydroxy group, an aryloxy group having 6 to 18 carbon atoms, an alkoxy group having 1 to 22 carbon atoms, or a group represented by Formula (III).

Examples of the aryloxy groups having 6 to 18 carbon atoms include a phenoxy group, an o-tolyloxy group, an m-tolyloxy group, a p-tolyloxy group, a 2,3-xylyloxy group, a 2,4-xylyloxy group, a 2,5-xylyloxy group, a 2,6-xylyloxy group, a 3,4-xylyloxy group, a 3,5-xylyloxy group, a 2,3,4-trimethylphenoxy group, a 2,3,5-trimethylphenoxy group, a 2,3,6-trimethylphenoxy group, a 2,4,6-trimethylphenoxy group, a 3,4,5-trimethylphenoxy group, a 2,3,4,5-tetramethylphenoxy group, a 2,3,4,6-tetramethylphenoxy group, a 2,3,5,6-tetramethylphenoxy group, a pentamethylphenoxy group, an ethylphenoxy group, an n-propylphenoxy group, an isopropylphenoxy group, an n-butylphenoxy group, a sec-butylphenoxy group, a tert-butylphenoxy group, an isobutylphenoxy group, an n-pentylphenoxy group, a neopentylphenoxy group, an n-hexylphenoxy group, an n-octylphenoxy group, an n-decylphenoxy group, an n-dodecylphenoxy group, an n-tetradecylphenoxy group, a naphthyloxy group, and an anthracenyloxy group.

Examples of the alkoxy group having 1 to 22 carbon atoms include a linear, branched, or cyclic alkoxy group such as a methoxy group, an ethoxy group, an n-propyloxy group, an isopropyloxy group, an n-butyloxy group, an isobutyloxy group, a sec-butyloxy group, a t-butyloxy group, an n-pentyloxy group, a neopentyloxy group, an n-hexyloxy group, an isohexyloxy group, an n-heptyloxy group, an n-octyloxy group, an n-nonyloxy group, an n-decyloxy group, an n-undecyloxy group, an n-dodecyloxy group, an n-tridecyloxy group, an n-tetradecyloxy group, an n-octadecyloxy group, an n-eicosyloxy group, an n-docosyloxy group, a 2-ethylhexyloxy group, a 3-ethylheptyloxy group, a 3-ethyldecyloxy group, a 2-hexyldecyloxy group, a cyclopentyloxy group, a cyclohexyloxy group, or a cycloheptyloxy group.

From the viewpoint of suppressing color mixing with the white toner using the bulky structure and from the viewpoint of excellent color developability of the compound, for example, it is preferable that Z₁ and Z₂ represent a group represented by Formula (III).

Examples of the alkyl group having 1 to 6 carbon atoms as R₃ to R₅ of Formula (III) include a methyl group, an ethyl group, an n-propyl group, an isopropyl group, an n-butyl group, an isobutyl group, a sec -butyl group, a t-butyl group, an n-pentyl group, a neopentyl group, and an n-hexyl group.

Examples of the aryl group having 6 to 18 carbon atoms include a phenyl group, an o-, m-, or p-tolyl group, a 2,3-xylyl group, a 2,4-xylyl group, a mesityl group, a naphthyl group, an anthryl group, a phenanthryl group, a triphenylenyl group, a tetrasenyl group, a chrysenyl group, a pyrenyl group, a pentasenyl group, and a picenyl group.

Examples of the alkoxy group having 1 to 6 carbon atoms include a methoxy group, an ethoxy group, an n-propyloxy group, an isopropyloxy group, an n-butyloxy group, an isobutyloxy group, a sec-butyloxy group, a t-butyloxy group, an n-pentyloxy group, a neopentyloxy group, an n-hexyloxy group, and an isohexyloxy group.

Examples of the phthalocyanine compound represented by Formula (II) are listed in Table 1 below. In addition, “-” in Table 1 indicates that the corresponding substituent is not included.

TABLE 1

| Compound | | | Ra₁ to Ra₄ |
|---|---|---|---|
| No. | M | Z₁ and Z₂ | (na₁ to na₄) |
| c1 | Si | —O—Si(CH₂CH₃)₃ | — |
| c2 | Si | —OH | — |
| c3 | Si | —O—Si(CH₃)₃ | Chloro group |
| | | | (all na₁ to na₄ |
| | | | represent 1) |
| c4 | Si | —O—Si(CH₂CH₂CH₃)₃ | — |
| c5 | Si | —O—Si(CH₂CH₂CH₂CH₂CH₂CH₃)₃ | — |
| c6 | Si | —O—Si(OCH₂CH₃)₃ | — |
| c7 | Si | —O—Si(C₆H₅)₃ | — |
| c8 | Si | —O—CH₃ | — |
| c9 | Si | —O—C₁₂H₂₅ | — |
| c10 | Si | —O—C₂₂H₄₅ | — |
| c11 | Si | —O—C₆H₅ | — |
| c12 | Ge | —O—Si(CH₂CH₃)₃ | — |
| c13 | Sn | —O—Si(CH₂CH₃)₃ | — |

The phthalocyanine-based compound represented by Formula (II) may be used alone or in combination of two or more kinds thereof.

As the phthalocyanine-based compound represented by Formula (II), a commercially available product or a synthetic product may be used. As the synthesis method, a known method may be used, and for example, the method described in JP2011-99047A can be employed.

As the dye, a known dye can be used, and specific examples of known dyes include, in addition to the pyrazolotriazole-based compound such as a pyrazolotriazole-based compound represented by Formula (I) and the phthalocyanine-based compound such as a phthalocyanine-based compound represented by Formula (II), Basic Red 1 (Rhodamine 6 GCP), Basic Red 1:1 (Rhodamine 6 GCP-N), Basic Red 2, Basic Red 12, Basic Red 13, Basic Red 14, Basic Red 15, Basic Red 36, Basic Violet 7, Basic Violet 10 (Rhodamine B), Basic Violet 11 (Rhodamine 3B), Basic Violet 11:1 (Rhodamine A), Basic Violet 15, Basic Violet 16, Basic Violet 27, Basic Violet 49, C.I. Pigment Yellow 101, Basic Yellow 1, Basic Yellow 2, Basic Yellow 9, Basic Yellow 24, Basic Yellow 40, Basic Orange 15, Basic Orange 22, Basic Blue 1, Basic Blue 3, Basic Blue 7, Basic Blue 9, Basic Blue 45, Basic Green 1, Acid Yellow 3, Acid Yellow 7, Acid Yellow 73, Acid Yellow 87, Acid Yellow 184, Acid Yellow 245, Acid Yellow 250, Acid Red 51, Acid Red 52, Acid Red 57, Acid Red 77, Acid Red 87, Acid Red 89, Acid Red 92, Acid Blue 9, Acid Black 2, Solvent Yellow 43, Solvent Yellow 44, Solvent Yellow 85, Solvent Yellow 98, Solvent Yellow 116, Solvent Yellow 131, Solvent Yellow 145, Solvent Yellow 160:1, Solvent Yellow 172, Solvent Yellow 185, Solvent Yellow 195, Solvent Yellow 196, Solvent Orange 63, Solvent Orange 112, Solvent Red 49, Solvent Red 149, Solvent Red 175, Solvent Red 196, Solvent Red 197, Solvent Blue 5, Solvent Green 5, Solvent Green 7, Direct Yellow 27, Direct Yellow 85, Direct Yellow 96, Direct Orange 8, Direct Red 2, Direct Red 9, Direct Blue 22, Direct Blue 199, Direct Green 6, Disperse Yellow 11, Disperse Yellow 82, Disperse Yellow 139, Disperse Yellow 184, Disperse Yellow 186, Disperse Yellow 199, Disperse Yellow 202, Disperse Yellow 232, Disperse Orange 11, Disperse Orange 32, Disperse Red 58, Disperse Red 274, Disperse Red 277, Disperse Red 303, Disperse Blue 7, Reactive Yellow 78, and Vat Red 41.

In the toner, the dye may be dispersed in the toner in the particle form or may be molecularly dispersed, but from the viewpoint of the property of suppressing fading in a high-temperature and high-humidity environment, for example, it is preferable that at least a part of the dye is dispersed in the toner in the particle form.

Among the dyes, the number average particle diameter of the dyes dispersed in the toner in the particle form is, for example, 10 nm or greater from the viewpoint of the property of suppressing fading in the high-temperature and high-humidity environment, and preferably 1,000 nm or less, more preferably 10 nm or greater and 500 nm or less, and still more preferably 10 nm or greater and 250 nm or less from the viewpoint of target color reproducibility.

The number average particle diameter of the dye dispersed in the toner particles in the particle form is measured by dyeing a cross section formed by cutting the toner or the toner particle and analyzing the observation image with a transmission electron microscope (TEM). Specifically, for example, a dyeing agent is appropriately selected from ruthenium tetroxide, osmium tetroxide, phosphotungstic acid, uranyl acetate, and iodine such that the dyeing condition of the binder resin and the dye differs depending on the kinds of the binder resin and the dye, as described below.

7 g of a bisphenol A type liquid epoxy resin (manufactured by Asahi Kasei Corporation) and 3 g of ZENAMID250 (manufactured by Henkel Japan Ltd.) serving as a curing agent are gently mixed and prepared, further mixed with 1 g of a toner, and allowed to stand for 24 hours, thereby obtaining a cured product. A cutting sample obtained by embedding the cured product at −100° C. is cut using a cutting device LEICA Ultra Microtome (model number, ULTRACUUT UCT, manufactured by Hitachi High-Tech Corporation) equipped with a diamond knife (model number, Type Cryo, manufactured by Diatome Ltd.) to create an observation sample. The observation sample is allowed to stand in a desiccator under a ruthenium tetroxide (manufactured by Soekawa Rikagaku Co., Ltd.) atmosphere and dyed (the dyeing condition is determined based on the dyeing condition of the tape allowed to stand simultaneously). With the stained observation sample, a cross-sectional view of the dyed toner is observed at a magnification of 10,000 to 100,000 times with a Hitachi high-resolution field emission scanning electron microscope (S-4800, manufactured by Hitachi High-Tech Corporation) equipped with a transmission electron detector. The number average particle diameter is calculated by observing cut surfaces of 300 toner particles from the TEM image to be observed, specifying the dyed portions in the toner particles based on the difference in dyeing condition, and measuring the dispersed particle diameters of the portions dispersed in the particle form. The dye portions based on the dyeing condition are determined by respectively dyeing the dye alone, the mixture of the dye and the binder resin, and the binder resin alone with the dyeing agent and comparing such materials.

The number average particle diameter of the portion where the dye is dispersed in the particle form may be calculated by digitizing the observed image and performing image processing. For example, the TEM image is digitized and taken in the image analysis software (Win ROOF, manufactured by Mitani Corporation), the toner cross-sectional area in the embedding agent is selected as the selection target, binarization processing is performed using an “automatic binarization-discriminant analysis method” of the “binarization processing” command, and the portion where the dye is dispersed in the particle form is separated from the binder resin portion. Here, it is confirmed, by comparison with the image before the binarization, whether the portion of the binarized image where the dye is dispersed in the particle form is separated by one particle at a time. In a case where a plurality of particles are connected and binarized, the binarization threshold is adjusted such that each particle is independently binarized, or the region is manually divided and the portion where the dye is dispersed in the particle form is modified such that the portion where each particle of the dye is dispersed in the particle form is formed. The region of the extracted portion where the dye is dispersed in the particle form is selected, and the maximum ferret diameter is acquired and defined as the particle diameter of the portion where the dye is dispersed in the particle form.

In a case where binarization cannot be performed normally due to the photographing density or noise of the photograph, the image is sharpened by performing “filter-median” processing or edge extraction processing, and the boundary may be set manually.

The toner A may contain only one or two or more kinds of dyes in combination.

From the viewpoint of further exhibiting the effects of the present exemplary embodiment, the content of the dye is, for example, preferably 0.01% by mass or greater and 30% by mass or less, more preferably 0.1% by mass or greater and 20% by mass or less, and particularly preferably 0.2% by mass or greater and 10% by mass or less with respect to the entirety of the resin particles.

### Acetylacetone Metal Compound

From the viewpoints of the property of suppressing fading in a high-temperature and high-humidity environment and the transparency, the toner A further contains, for example, preferably an acetylacetone metal compound and more preferably a pyrazolotriazole-based compound represented by Formula (I) and an acetylacetone metal compound.

In the toner particles, the pyrazolotriazole-based dye and the acetylacetone metal compound form a partial complex, which acts as a nucleating agent during cooling after fixation of the toner and suppresses transfer of the toner to the surface, and thus the property of suppressing fading in a high-temperature and high-humidity environment and the transparency are assumed to be more excellent.

The acetylacetone metal compound is not particularly limited, but from the viewpoints of the property of suppressing color transfer and transparency of an image to be obtained, for example, an acetylacetone metal compound containing an electron-withdrawing group is preferable, an acetylacetone copper, nickel, or cobalt compound containing an electron-withdrawing group is more preferable, and a compound represented by Formula (IV) is particularly preferable.

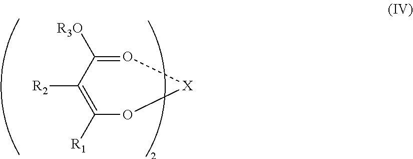

In Formula (IV), R₁ and R₂ each independently represent a hydrogen atom, an alkyl group, an alkenyl group, an alkynyl group, an aryl group, an aliphatic heterocyclic group, an aromatic heterocyclic group, an alkoxycarbonyl group, an aryloxycarbonyl group, a sulfamoyl group, a sulfinyl group, an alkylsulfonyl group, an arylsulfonyl group, a cyano group, a trifluoroalkyl group, or a nitro group, at least one of R₁ or R₂ represents an electron-withdrawing group, R₃ represents an alkyl group, an alkenyl group, an alkynyl group, an aryl group, an aliphatic heterocyclic group, or an aromatic heterocyclic group, R₂ and R₃ may be bonded to each other to form a ring, and X represents any metal atom such as copper, nickel, or cobalt.

For example, the total number of carbon atoms in one molecule of an acetylacetone ligand in the compound represented by Formula (IV) is preferably 25 or less.

### R₁ and R₂

R₁ and R₂ each independently represent a hydrogen atom, an alkyl group, an alkenyl group, an alkynyl group, an aryl group, an aliphatic heterocyclic group, an aromatic heterocyclic group, a halogen alkyl group, an alkoxy group, a cycloalkoxy group, an aryloxy group, an alkylthio group, a cycloalkylthio group, an arylthio group, an alkoxycarbonyl group, an aryloxycarbonyl group, a sulfamoyl group, an acyl group, an acyloxy group, an amide group, a carbamoyl group, a ureido group, a sulfinyl group, an alkylsulfonyl group, an arylsulfonyl group, or an amino group. The combination of R₁ and R₂ is not particularly limited, but any one of R₁ or R₂ represents an electron-withdrawing group.

The alkyl group may be any of a linear alkyl group, a branched alkyl group, or a cycloalkyl group, and examples thereof include a methyl group, an ethyl group, a propyl group, an isopropyl group, a tert-butyl group, a pentyl group, a cyclopentyl group, a hexyl group, a cyclohexyl group, an octyl group, a dodecyl group, a tridecyl group, a tetradecyl group, and a pentadecyl group.

Examples of the alkenyl group include a vinyl group and an allyl group.

Examples of the alkynyl group include an ethynyl group and a propargyl group.

Examples of the aryl group include a phenyl group and a naphthyl group.

Examples of the aliphatic heterocyclic group include a pyrrolidyl group, an imidazolidyl group, a morphoryl group, and an oxazolidyl group.

Examples of the aromatic heterocyclic group includes a furyl group, a thienyl group, a pyridyl group, a pyridazyl group, a pyrimidyl group, a pyrazyl group, a triazyl group, an imidazolyl group, a pyrazolyl group, a thiazolyl group, a benzimidazolyl group, a benzoxazolyl group, a quinazolyl group, and a phthalazyl group.

The halogen alkyl group may be a monohalogen alkyl group, a dihalogen alkyl group, or a trihalogen alkyl group. The halogen may be fluorine, chlorine, bromine, or iodine. The alkyl group is not particularly limited and may be a methyl group, an ethyl group, or a propyl group.

Examples of the alkoxy group include a methoxy group, an ethoxy group, a propyloxy group, a pentyloxy group, a hexyloxy group, an octyloxy group, and a dodecyloxy group.

Examples of the cycloalkoxy group include a cyclopentyloxy group and a cyclohexyloxy group.

Examples of the aryloxy group include a phenoxy group and a naphthyloxy group.

Examples of the alkylthio group include a methylthio group, an ethylthio group, a propylthio group, a pentylthio group, a hexylthio group, an octylthio group, and a dodecylthio group.

Examples of the cycloalkylthio group include a cyclopentylthio group and a cyclohexylthio group.

Examples of the arylthio group include a phenylthio group and a naphthylthio group.

Examples of the alkoxycarbonyl group include a methyloxycarbonyl group, an ethyloxycarbonyl group, a butyloxycarbonyl group, an octyloxycarbonyl group, and a dodecyloxycarbonyl group.

Examples of the aryloxycarbonyl group include a phenyloxycarbonyl group and a naphthyloxycarbonyl group.

Examples of the sulfamoyl group includes an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group, and a 2-pyridylaminosulfonyl group.

Examples of the acyl group include an acetyl group, an ethylcarbonyl group, a propylcarbonyl group, a pentylcarbonyl group, a cyclohexylcarbonyl group, an octylcarbonyl group, a 2-ethylhexylcarbonyl group, a dodecylcarbonyl group, a phenylcarbonyl group, a naphthylcarbonyl group, and a pyridylcarbonyl group.

Examples of the acyloxy group include an acetyloxy group, an ethylcarbonyloxy group, a butylcarbonyloxy group, an octylcarbonyloxy group, a dodecylcarbonyloxy group, and a phenylcarbonyloxy group.

Examples of the amide group include a methylcarbonylamino group, an ethylcarbonylamino group, a dimethylcarbonylamino group, a propylcarbonylamino group, a pentylcarbonylamino group, a cyclohexylcarbonylamino group, a 2-ethylhexylcarbonylamino group, an octylcarbonylamino group, a dodecylcarbonylamino group, a phenylcarbonylamino group, and a naphthylcarbonylamino group.

Examples of the carbamoyl group includes an aminocarbonyl group, a methylaminocarbonyl group, a dimethylaminocarbonyl group, a propylaminocarbonyl group, a pentylaminocarbonyl group, a cyclohexylaminocarbonyl group, an octylaminocarbonyl group, a 2-ethylhexylaminocarbonyl group, a dodecylaminocarbonyl group, a phenylaminocarbonyl group, a naphthylaminocarbonyl group, and a 2-pyridylaminocarbonyl group.

Examples of the ureido group include a methylureido group, an ethylureido group, a pentylureido group, a cyclohexylureido group, an octylureido group, a dodecylureido group, a phenylureido group, a naphthylureido group, and a 2-pyridylaminoureido group.

Examples of the sulfinyl group include a methylsulfinyl group, an ethylsulfinyl group, a butylsulfinyl group, a cyclohexylsulfinyl group, a 2-ethylhexylsulfinyl group, a dodecylsulfinyl group, a phenylsulfinyl group, a naphthylsulfinyl group, and a 2-pyridylsulfinyl group.

Examples of the alkylsulfonyl group include a methylsulfonyl group, an ethylsulfonyl group, a butylsulfonyl group, a cyclohexylsulfonyl group, a 2-ethylhexylsulfonyl group, and a dodecylsulfonyl group.

Examples of the arylsulfonyl group include a phenylsulfonyl group, a naphthylsulfonyl group, and a 2-pyridylsulfonyl group.

Examples of the amino group include a methylamino group, an ethylamino group, a dimethylamino group, a butylamino group, a cyclopentylamino group, a 2-ethylhexylamino group, a dodecylamino group, an anilino group, a naphthylamino group, and a 2-pyridylamino group.

Further, R₁ and R₂ may each independently represent a cyano group, a nitro group, or a halogen atom in addition to the above-described substituents.

Among the above-described substituents, it is preferable that R₁ and R₂ each independently represent, for example, an alkyl group, a trifluoroalkyl group, an aryl group, an aliphatic heterocyclic group, an aromatic heterocyclic group, an alkoxy group, a sulfamoyl group, a ureido group, an amino group, an amide group, an acyl group, an alkoxycarbonyl group, a carbamoyl group, a cyano group, or a halogen atom. R₁ and R₂ each independently represent, for example, more preferably an alkyl group, a trifluoroalkyl group, a cyano group, an alkoxy group, an amide group, or a halogen atom and still more preferably a trifluoroalkyl group, a cyano group, or an alkoxy group.

R₁ and R₂ may each independently represent a group to which a substituent other than the above-described substituent is bonded. The substituent bonded to the substituent may be the same substituent as the substituent described above or may be a substituent different from the substituent described above.

### R₃

R₃ represents any of an alkyl group, an alkenyl group, an alkynyl group, an aryl group, an aliphatic heterocyclic group, an aromatic heterocyclic group, or an ether group shown below. In a case where R₃ represents an alkyl group, an alkenyl group, an alkynyl group, or an ether group, for example, the number of carbon atoms is preferably 3 or greater. Specific examples for each of the alkyl group, the alkenyl group, the alkynyl group, the aryl group, and the heterocyclic group may be the specific examples represented by R₁ and R₂.

### X

X represents, for example, any metal atom such as copper, nickel, or cobalt and preferably copper.

Specific examples of the compound represented by Formula (IV) include compounds represented by Formulae (II-1) to (II-85) shown below, but it goes without saying that the compounds are not limited to the specific examples shown below. The structural formulae shown below are examples of the resonance structures that can be employed by the exemplary compounds. In the formulae, the distinction between the covalent bond indicated by the solid line and the coordinate bond indicated by the broken line is not absolute distinction but a formal distinction.

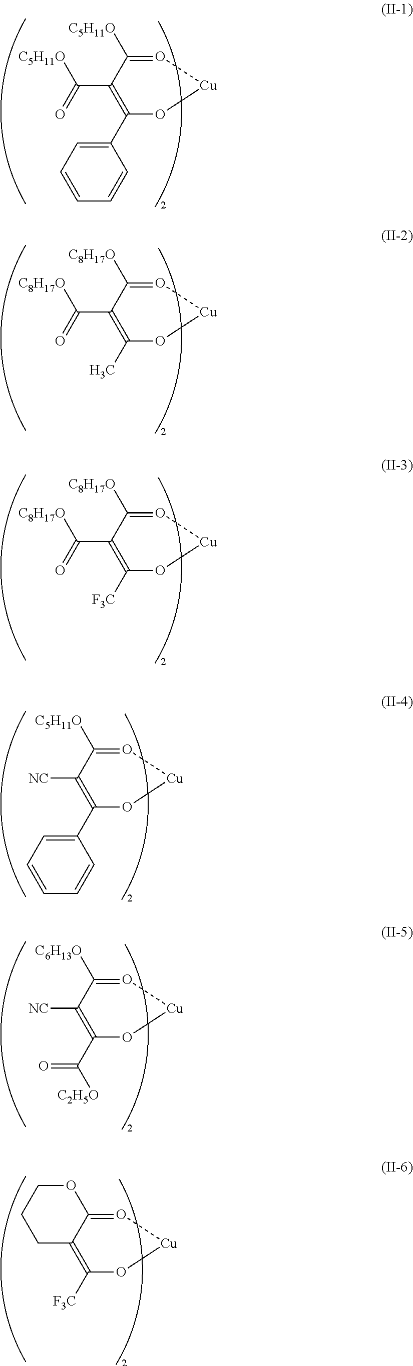

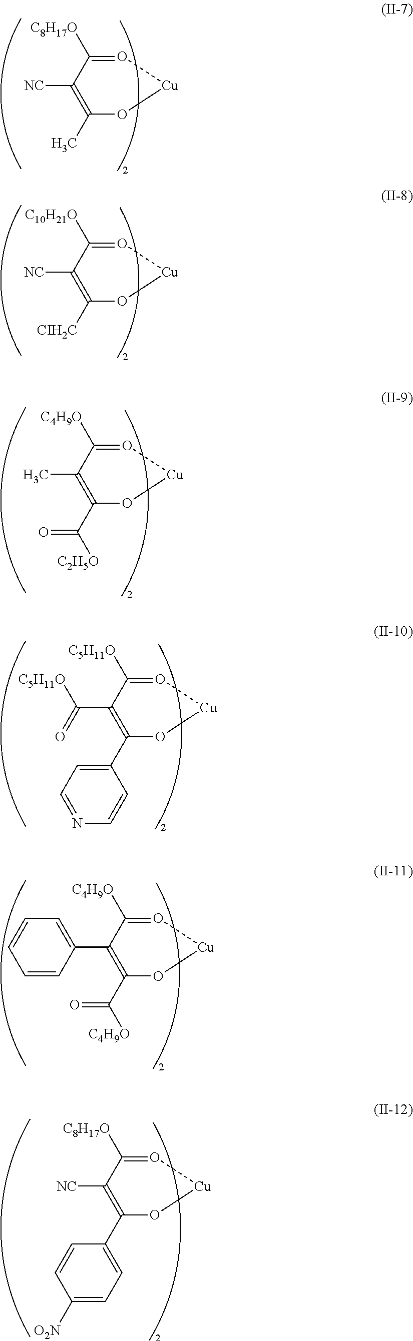

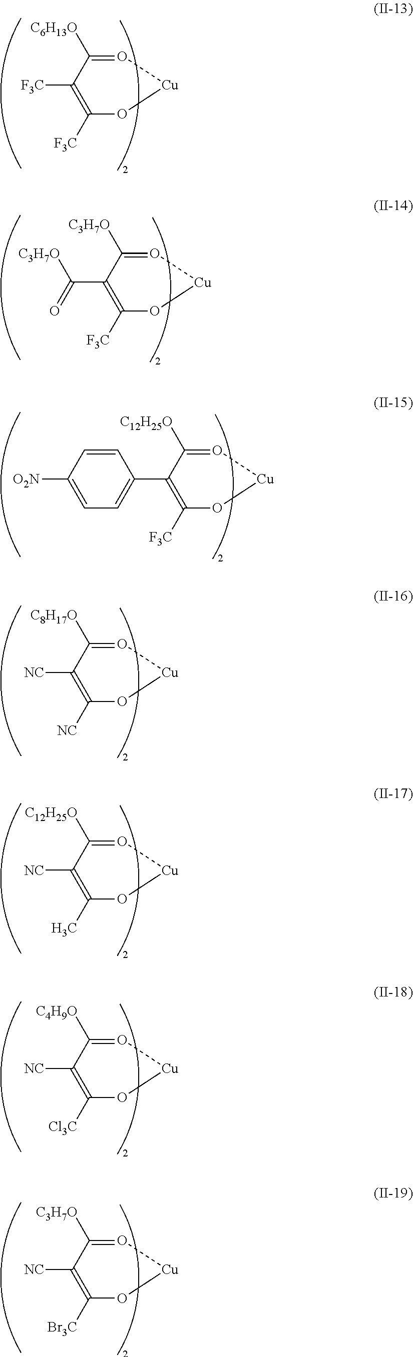

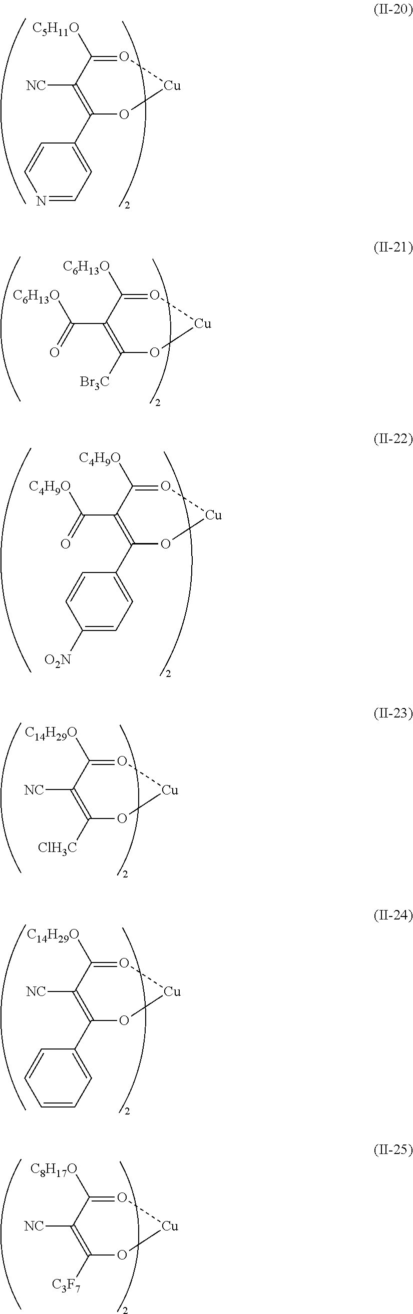

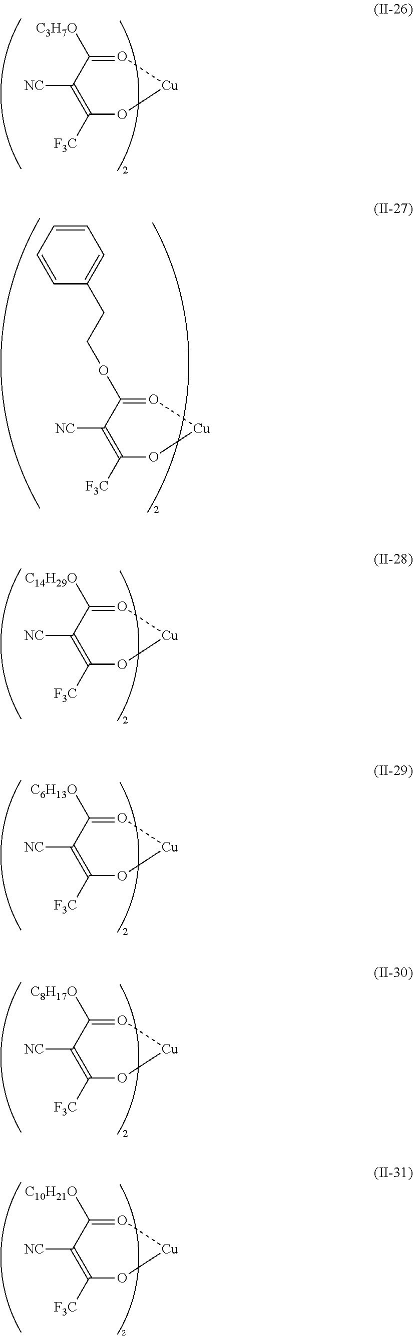

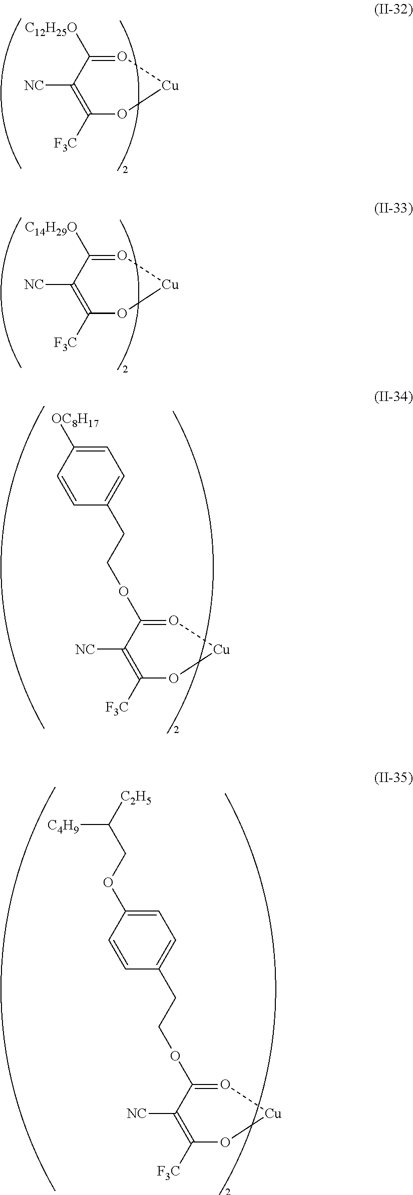

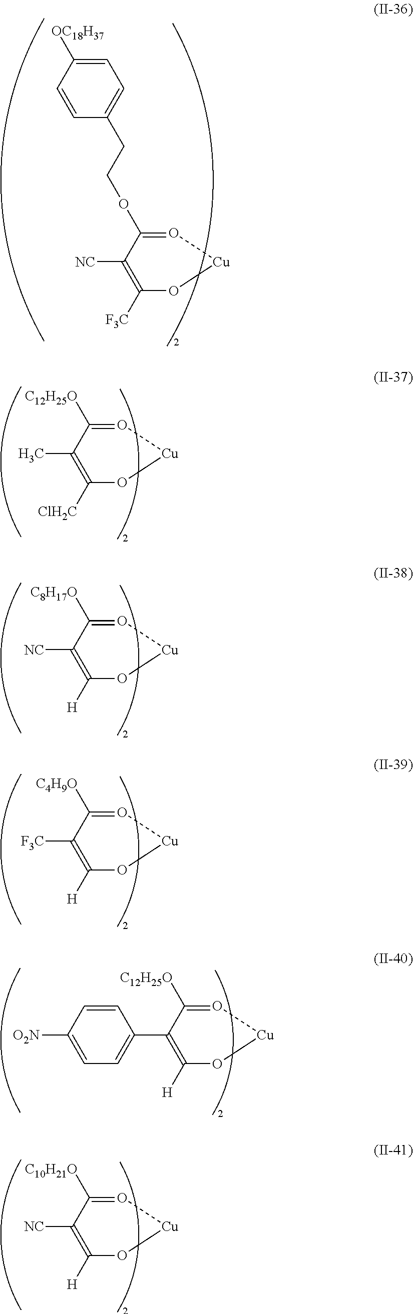

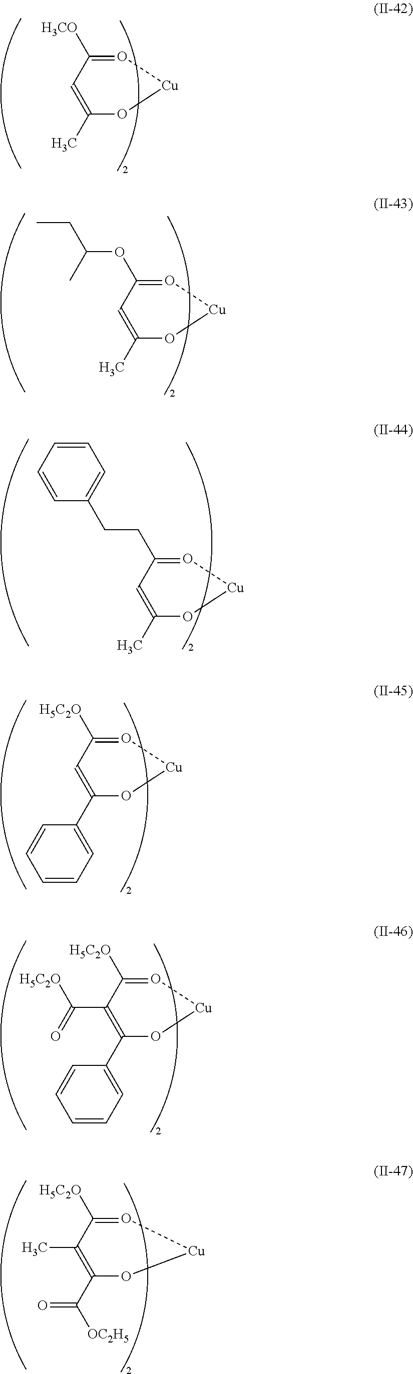

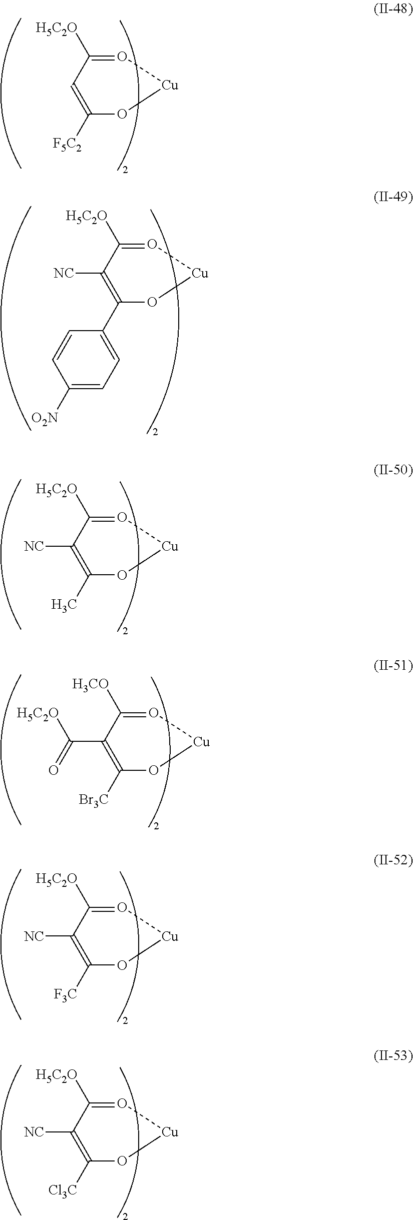

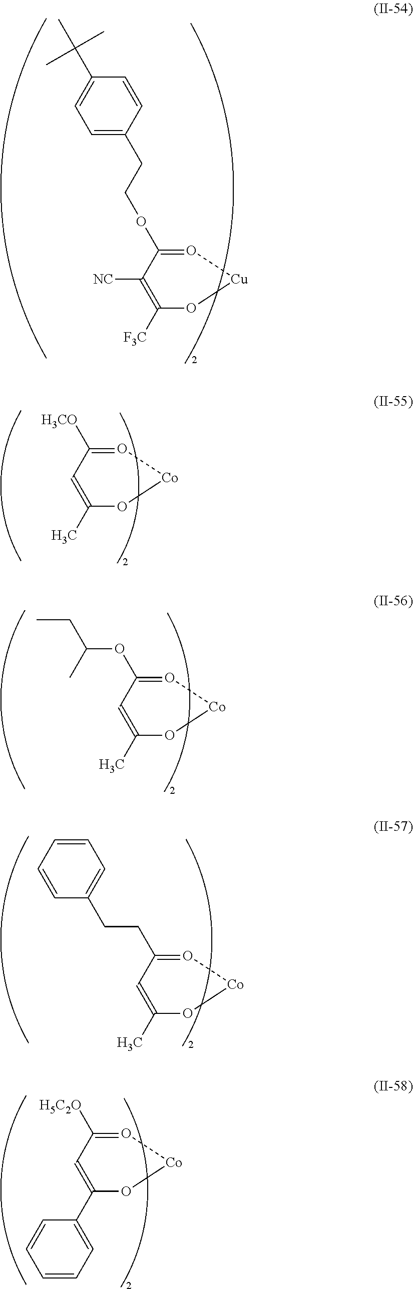

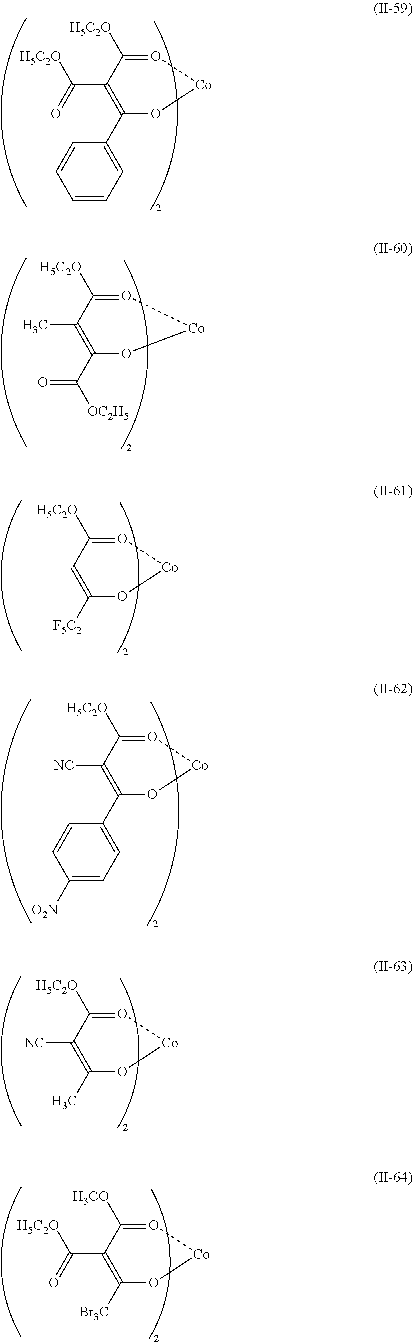

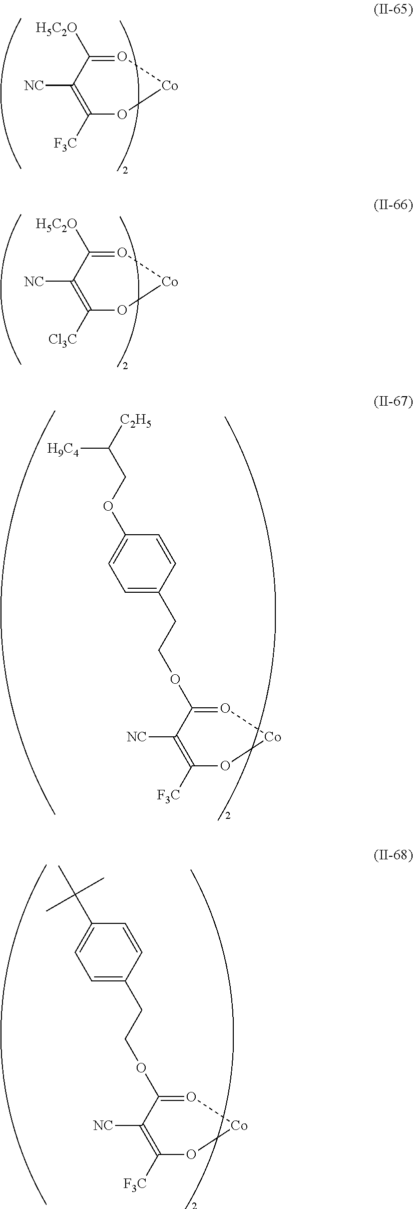

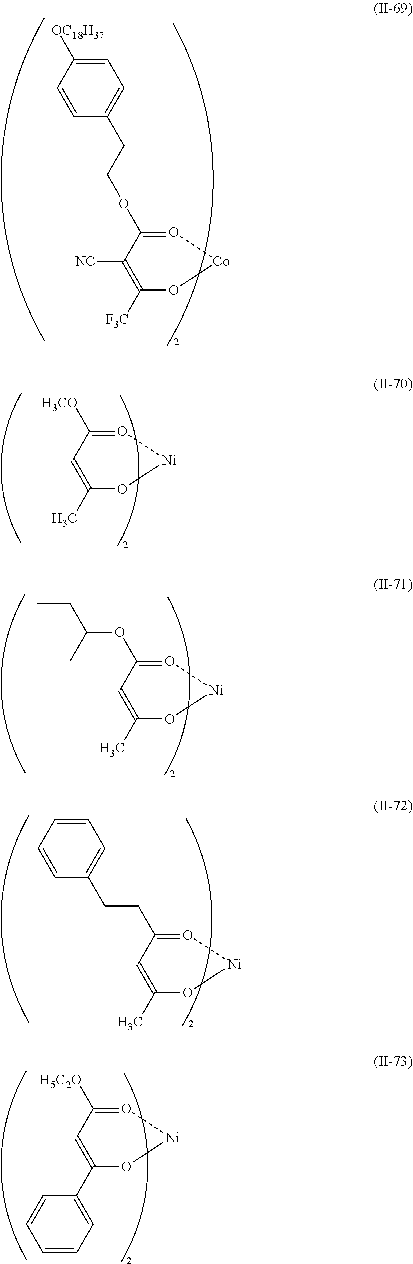

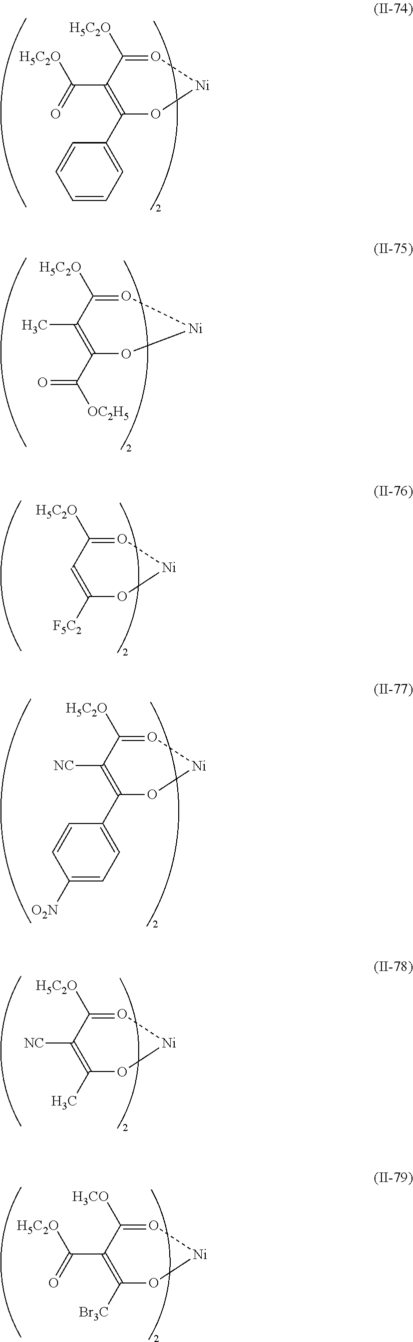

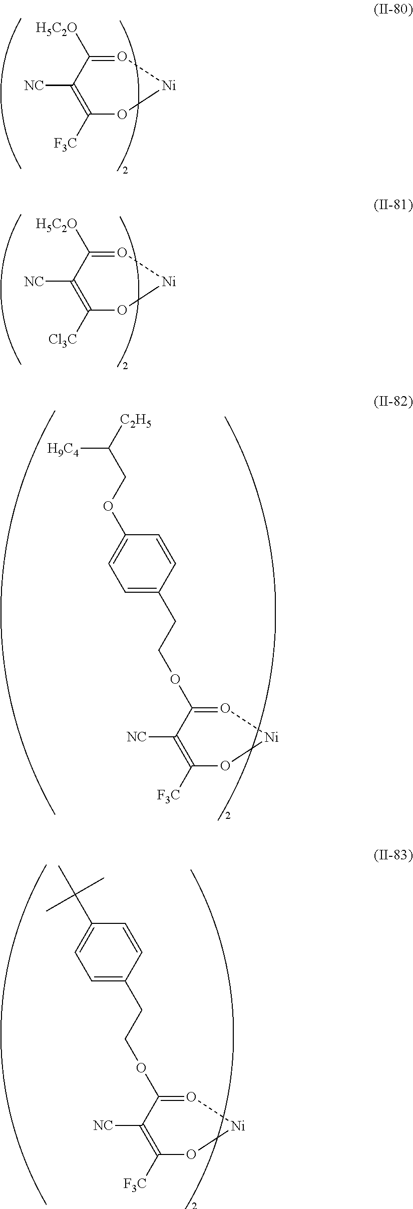

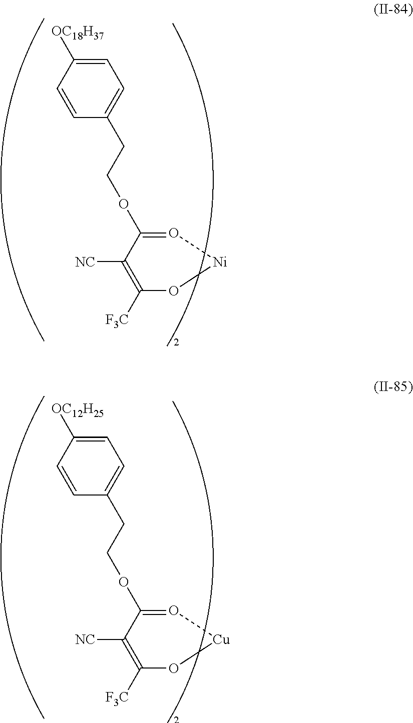

The acetylacetone metal compound contained in the toner particles may be used alone or in combination of two or more kinds thereof.

From the viewpoints of the property of suppressing fading in a high-temperature and high-humidity environment and the transparency, the content of the acetylacetone metal compound is, for example, preferably 0.5% by mass or greater and 30% by mass or less, more preferably 1% by mass or greater and 25% by mass or less, and particularly preferably 2% by mass or greater and 20% by mass or less with respect to the total mass of the toner particles.

From the viewpoints of the property of suppressing fading in a high-temperature and high-humidity environment and the transparency, the content ratio of the acetylacetone metal compound to the pyrazolotriazole-based dye in the toner particles (content of acetylacetone metal compound/content of pyrazolotriazole-based dye) is, for example, preferably 1 or greater and 10 or less, more preferably 1.2 or greater and 5 or less, and particularly preferably 1.5 or greater and 3 or less.

### Titanium Oxide Pigment

The white toner B contains a titanium oxide pigment. The crystal structure of the titanium oxide pigment may be any of an anatase type, a rutile type, or a brookite type, but from the viewpoint of further exhibiting the effects of the present exemplary embodiment, for example, the rutile type having low photocatalytic activity is preferable. As the titanium oxide pigment, a surface-treated pigment may be used as necessary, or a combination with a dispersant may be used.

From the viewpoint of color developability, the number average particle diameter of the titanium oxide pigment contained in the white toner B is, for example, preferably 150 nm or greater and 900 nm or less, more preferably 180 nm or greater and 800 nm or less, and particularly preferably 200 nm or greater and 700 nm or less.

The number average particle diameter of the titanium oxide pigment in the white toner B according to the present exemplary embodiment is, for example, calculated in the following manner.

The white toner according to the present exemplary embodiment is mixed with an epoxy resin, embedded, and solidified by being allowed to stand overnight, and for example, a thin piece having a thickness of 250 nm or greater and 450 nm or less is prepared using an ultramicrotome device (UltracutUCT, manufactured by Leica).

The obtained thin piece is observed with an ultra-high resolution field emission scanning electron microscope (S-4800, manufactured by Hitachi High-Tech Corporation), and the white colored particles inside the white toner particles are confirmed. In a case where the contour portion of the white colored particles is not clear, the thickness of the thin piece to be observed can be adjusted and re-observed. In a case where many blank defects are present inside the white toner particles, since the white colored particles may have fallen off during the preparation of the thin pieces, for example, it is preferable that the thickness of the thin pieces is adjusted to be larger. In a case where the outline of the white colored particles is difficult to distinguish because most of the white colored particles inside the white toner particles appear to overlap with each other, a plurality of white colored particles may be observed such that the particles overlap with each other due to an overlarge thickness of the thin pieces, and thus, for example, it is preferable that the thickness of the thin pieces is adjusted to be small.

The observed photograph is digitized and taken in the image analysis software (Win ROOF, manufactured by Mitani Corporation), for example, the number average particle diameter of the white colored particles in the white toner particles and the proportion of the white colored particles having a particle diameter of 350 nm or greater and 600 nm or less in the entirety of the white colored particles are acquired according to the following procedures.

That is, the toner cross-sectional area in the embedding agent is selected as the selection target, binarization processing is performed using an “automatic binarization-discriminant analysis method” of the “binarization processing” command, and the white colored particles and the binder resin portion are separated from each other. Here, it is confirmed, by comparison with the image before the binarization, whether the white colored particle region portion of the binarized image is separated by one white colored particle at a time. In a case where a plurality of particles are connected and binarized, modification is made such that the binarization threshold is adjusted to binarize each particle independently, or the region is manually divided and each white colored particle region portion is formed with one white colored particle. The extracted white colored particle region is selected, and the maximum ferret diameter is acquired and defined as the particle diameter of the white colored particles.

In a case where binarization cannot be performed normally due to the photographing density or noise of the photograph, the image is sharpened by performing “filter-median” processing or edge extraction processing, and the boundary may be set manually.

The number average particle diameter of the white colored particles is calculated by acquiring the measured values of 300 or more white colored particles using an image in which approximately 10 or more and 100 or less pigment particles are viewed in one field, and the arithmetic average value is used.

The titanium oxide pigment may be used alone or in combination of two or more kinds thereof.

The content of the titanium oxide pigment is, for example, preferably 10% by mass or greater and 70% by mass or less, more preferably 15% by mass or greater and 60% by mass or less, and particularly preferably 20% by mass or greater and 55% by mass or less with respect to the entirety of the toner particles.

### Binder Resin

From the viewpoints of the image intensity and suppressing density unevenness in an image to be obtained, it is preferable that the binder resin contains, for example, an amorphous resin and a crystalline resin.

Further, in the first exemplary embodiment of the electrostatic charge image developing toner set according to the present exemplary embodiment, for example, a polyester resin, a styrene acrylic resin, or an acrylic resin is preferable as the binder resin.

Here, the amorphous resin is a resin that shows only a stepwise endothermic change without having a clear endothermic peak in the thermal analysis measurement using differential scanning calorimetry (DSC), and is a solid at room temperature and thermoplasticized at a temperature higher than or equal to the glass transition temperature.

On the other hand, the crystalline resin indicates a resin having a clear endothermic peak without showing a stepwise change in endothermic amount in differential scanning calorimetry (DSC).

Specifically, for example, the crystalline resin means that the half-width of the endothermic peak which is measured at a temperature rising rate of 10° C./min is 10° C. or lower, and the amorphous resin means a resin having a half-width of higher than 10° C. or a resin in which a clear endothermic peak is not observed.

The amorphous resin will be described.

Examples of the amorphous resin include an amorphous polyester resin and an amorphous styrene acrylic resin.

Further, a combination of an amorphous polyester resin and a styrene acrylic resin may be used as the amorphous resin.

Examples of the amorphous polyester resin include a condensed polymer of a polyvalent carboxylic acid and a polyhydric alcohol. As the amorphous polyester resin, a commercially available product or a synthesized product may be used.

Examples of the polyvalent carboxylic acid include an aliphatic dicarboxylic acid (for example, oxalic acid, malonic acid, maleic acid, fumaric acid, citraconic acid, itaconic acid, glutaconic acid, succinic acid, alkenyl succinic acid, adipic acid, or sebacic acid), an alicyclic dicarboxylic acid (for example, cyclohexanedicarboxylic acid), an aromatic dicarboxylic acid (for example, terephthalic acid, isophthalic acid, phthalic acid, or naphthalenedicarboxylic acid), an anhydride thereof, and lower (for example, having 1 or more and 5 or less carbon atoms) alkyl ester thereof. Among the examples, for example, an aromatic dicarboxylic acid is preferable as the polyvalent carboxylic acid.

As the polyvalent carboxylic acid, a combination of a dicarboxylic acid with a trivalent or higher valent carboxylic acid having a crosslinked structure or a branched structure may be used. Examples of the trivalent or higher valent carboxylic acid include trimellitic acid, pyromellitic acid, an anhydride thereof, and lower (for example, having 1 or more and 5 or less carbon atoms) alkyl ester thereof.

The polyvalent carboxylic acid may be used alone or in combination of two or more kinds thereof.

Examples of the polyhydric alcohol include an aliphatic diol (such as ethylene glycol, diethylene glycol, triethylene glycol, propylene glycol, butanediol, hexanediol, or neopentyl glycol), an alicyclic diol (such as cyclohexanediol, cyclohexanedimethanol, or hydrogenated bisphenol A) and an aromatic diol (such as an ethylene oxide adduct of bisphenol A or a propylene oxide adduct of bisphenol A). Among the examples, as the polyhydric alcohol, for example, an aromatic diol or an alicyclic diol is preferable, and an aromatic diol is more preferable.

As the polyhydric alcohol, a combination of a diol with a trihydric or higher polyhydric alcohol having a crosslinked structure or a branched structure may be used. Examples of the trihydric or higher polyhydric alcohol include glycerin, trimethylolpropane, and pentaerythritol.

The polyhydric alcohol may be used alone or in combination of two or more kinds thereof.

The amorphous polyester resin is obtained by a known production method. Specifically, for example, the amorphous polyester resin is obtained by a method of setting the polymerization temperature to 180° C. or higher and 230° C. or lower, reducing the pressure inside the reaction system as necessary, and carrying out the reaction while removing water and alcohol generated during condensation. In a case where the raw material monomer is not dissolved or compatible at the reaction temperature, a solvent having a high boiling point may be added as a dissolution assistant to dissolve the monomer. In this case, the polycondensation reaction is carried out while the dissolution assistant is distilled off. In a case where a monomer with poor compatibility is present in the copolymerization reaction, for example, the monomer with poor compatibility may be condensed with an acid or an alcohol to be polycondensed with the monomer in advance, and then polycondensed with the main component.

The styrene acrylic resin is, for example, a copolymer obtained by copolymerizing at least a styrene-based monomer (a monomer having a styrene skeleton) and a (meth)acrylic monomer (a monomer containing a (meth)acrylic group and preferably a monomer containing a (meth)acryloxy group). The styrene acrylic resin includes, for example, a copolymer of a monomer of styrenes and a monomer of (meth)acrylic acid esters.

Further, the acrylic resin portion in the styrene acrylic resin has a partial structure obtained by polymerizing any one or both of an acrylic monomer and a methacrylic monomer. Further, “(meth)acryl” is an expression including both “acryl” and “methacryl”.

Specific examples of the styrene-based monomer include styrene, alkyl-substituted styrene (such as a-methylstyrene, 2-methylstyrene, 3-methylstyrene, 4-methylstyrene, 2-ethylstyrene, 3-ethylstyrene, or 4-ethylstyrene), halogen-substituted styrene (such as 2-chlorostyrene, 3-chlorostyrene, or 4-chlorostyrene), and vinylnaphthalene. The styrene-based monomer may be used alone or in combination of two or more kinds thereof.

Among the examples, from the viewpoints of ease of reaction, ease of control of reaction, and availability, as further the styrene-based monomer, for example, styrene is preferable.

Specific examples of the (meth)acrylic monomer include (meth)acrylic acid and (meth)acrylic acid ester. Examples of the (meth)acrylic acid ester include (meth)acrylic acid alkyl ester (such as methyl (meth)acrylate, ethyl (meth) acrylate, n-propyl (meth) acrylate, n-butyl (meth) acrylate, n-pentyl (meth) acrylate, n-hexyl (meth) acrylate, n-heptyl (meth) acrylate, n-octyl (meth) acrylate, n-decyl (meth) acrylate, n-dodecyl (meth) acrylate, n-lauryl (meth) acrylate, n-tetradecyl (meth) acrylate, n-hexadecyl (meth) acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, cyclohexyl (meth)acrylate, or butylcyclohexyl (meth)acrylate), (meth)acrylic acid aryl ester (such as phenyl (meth)acrylate, biphenyl (meth) acrylate, diphenylethyl (meth) acrylate, t-butylphenyl (meth)acrylate, or terphenyl (meth)acrylate), dimethylaminoethyl (meth) acrylate, diethylaminoethyl (meth)acrylate, methoxyethyl (meth)acrylate, 2-hydroxyethyl (meth)acrylate, β-carboxyethyl (meth)acrylate, and (meth)acrylamide. The (meth)acrylic acid-based monomer may be used alone or in combination of two or more kinds thereof.

Among the (meth)acrylic monomers, from the viewpoint of the fixability, for example, (meth)acrylic acid ester containing an alkyl group having 2 or more and 14 or less carbon atoms (for example, preferably 2 or more and 10 or less carbon atoms and more preferably 3 or more and 8 or less carbon atoms) is preferable from among the (meth)acrylic esters.

Among the examples, for example, n-butyl (meth)acrylate is preferable, and n-butyl acrylate is particularly preferable.

The copolymerization ratio (on a mass basis, styrene-based monomer/(meth)acrylic monomer) of the styrene-based monomer to the (meth)acrylic monomer is not particularly limited, but is preferably in a range of 85/15 to 70/30.

The styrene acrylic resin may have a crosslinked structure. As the styrene acrylic resin having a crosslinked structure, for example, resins obtained by copolymerizing at least a styrene-based monomer, a (meth)acrylic acid-based monomer, and a crosslinkable monomer are preferable.

Examples of the crosslinkable monomer include bifunctional or higher functional crosslinking agents.

Examples of the bifunctional crosslinking agent include divinylbenzene, divinylnaphthalene, a di(meth)acrylate compound (such as diethylene glycol di(meth)acrylate, methylenebis(meth)acrylamide, decanediol diacrylate, or glycidyl (meth)acrylate), polyester-type di(meth)acrylate, and 2-([1′-methylpropylideneamino]carboxyamino)ethyl methacrylate.

Examples of the polyfunctional crosslinking agent include a tri(meth)acrylate compound (such as pentaerythritol tri(meth)acrylate, trimethylolethanetri(meth)acrylate, or trimethylolpropane tri(meth)acrylate), a tetra(meth)acrylate compound (such as pentaerythritol tetra(meth)acrylate or oligoester (meth)acrylate), 2,2-bis(4-methacryloxy polyethoxyphenyl)propane, diallyl phthalate, triallyl cyanurate, triallyl isocyanurate, triallyl trimellitate, and diallyl chlorendate.

Among the examples, from the viewpoints of suppressing a decrease in image density, suppressing image density unevenness from occurring, and the fixability, as the crosslinkable monomer, for example, a bifunctional or higher functional (meth)acrylate compound is preferable, a bifunctional (meth)acrylate compound is more preferable, a bifunctional (meth)acrylate compound containing an alkylene group having 6 or more and 20 or less carbon atoms is still more preferable, and a bifunctional (meth)acrylate compound containing a linear alkylene group having 6 or more and 20 or less carbon atoms is particularly preferable.

The copolymerization ratio of the crosslinkable monomer to all the monomers (on a mass basis, crosslinkable monomer/all monomers) is not particularly limited, but is preferably in a range of 2/1,000 to 20/1,000.

A method of preparing the styrene acrylic resin is not particularly limited, and various polymerization methods (for example, solution polymerization, precipitation polymerization, suspension polymerization, bulk polymerization, and emulsion polymerization) are applied. A known operation (for example, a batch type, semi-continuous type, or continuous type operation) is applied to the polymerization reaction.

The proportion of the styrene acrylic resin in all the binder resins is, for example, preferably 0% by mass or greater and 20% by mass or less, more preferably 1% by mass or greater and 15% by mass or less, and still more preferably 2% by mass or greater and 10% by mass or less.

The proportion of the amorphous resin in all the binder resins is, for example, preferably 60% by mass or greater and 98% by mass or less, more preferably 65% by mass or greater and 95% by mass or less, and still more preferably 70% by mass or greater and 90% by mass or less.

The characteristics of the amorphous resin will be described.

The glass transition temperature (Tg) of the amorphous resin is, for example, preferably 50° C. or higher and 80° C. or lower and more preferably 50° C. or higher and 65° C. or lower.

Further, the glass transition temperature is acquired from the DSC curve obtained by differential scanning calorimetry (DSC) and more specifically acquired by the “extrapolated glass transition start temperature” described in the method of acquiring the glass transition temperature in JIS K 7121-1987 “Method of measuring transition temperature of plastics”.

The weight-average molecular weight (Mw) of the amorphous resin is, for example, preferably 5,000 or greater and 1,000,000 or less and more preferably 7,000 or greater and 500,000 or less.

The number average molecular weight (Mn) of the amorphous resin is, for example, preferably 2,000 or greater and 100,000 or less.

The molecular weight distribution Mw/Mn of the amorphous resin is, for example, preferably 1.5 or greater and 100 or less and more preferably 2 or greater and 60 or less.

Further, the weight-average molecular weight and the number average molecular weight are measured by gel permeation chromatography (GPC). The molecular weight is measured by GPC using GPC/HLC-8120 GPC (manufactured by Tosoh Corporation) as a measuring device, TSKgel SuperHM-M (15 cm) (manufactured by Tosoh Corporation) as a column, and a THF solvent. The weight-average molecular weight and the number average molecular weight are calculated using a molecular weight calibration curve created by a monodisperse polystyrene standard sample based on the measurement results.

The crystalline resin will be described. Examples of the crystalline resin include known crystalline resins such as a crystalline polyester resin and a crystalline vinyl resin (for example, a polyalkylene resin or a long-chain alkyl (meth)acrylate resin). Among the examples, from the viewpoint of suppressing density unevenness and suppressing whitened spots in an image to be obtained, for example, a crystalline polyester resin is preferable.

Examples of the crystalline polyester resin include a polycondensate of a polyvalent carboxylic acid and a polyhydric alcohol. As the crystalline polyester resin, a commercially available product or a synthesized product may be used.

Since the crystalline polyester resin easily forms, for example, a crystal structure, a polycondensate obtained by using a linear aliphatic polymerizable monomer is preferable to a polymerizable monomer having an aromatic ring.

Examples of the polyvalent carboxylic acid include an aliphatic dicarboxylic acid (for example, oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, or 1,18-octadecanedicarboxylic acid), an aromatic dicarboxylic acid (for example, a dibasic acid such as phthalic acid, isophthalic acid, terephthalic acid, or naphthalene-2,6-dicarboxylic acid), an anhydride thereof, and lower (for example, having 1 or more and 5 or less carbon atoms) alkyl ester thereof.

As the polyvalent carboxylic acid, a combination of a dicarboxylic acid with a trivalent or higher valent carboxylic acid having a crosslinked structure or a branched structure may be used. Examples of the trivalent carboxylic acid include an aromatic carboxylic acid (for example, 1,2,3-benzenetricarboxylic acid, 1,2,4-benzenetricarboxylic acid, or 1,2,4-naphthalenetricarboxylic acid), an anhydride thereof, and lower (for example, having 1 or more and 5 or less carbon atoms) alkyl ester thereof.

As the polyvalent carboxylic acid, a combination of the examples dicarboxylic acids with a dicarboxylic acid containing a sulfonic acid group and a dicarboxylic acid having an ethylenic double bond may be used.

The polyvalent carboxylic acid may be used alone or in combination of two or more kinds thereof.

Examples of the polyhydric alcohol include an aliphatic diol (for example, a linear aliphatic diol having a main chain portion with 7 or more and 20 or less carbon atoms). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among the examples, for example, 1,8-octanediol, 1,9-nonanediol, or 1,10-decanediol is preferable as the aliphatic diol.

As the polyhydric alcohol, a combination of a diol with a trihydric or higher polyhydric alcohol having a crosslinked structure or a branched structure may be used. Examples of the trihydric or higher polyhydric alcohol include glycerin, trimethylolethane, trimethylolpropane, and pentaerythritol.

The polyhydric alcohol may be used alone or in combination of two or more kinds thereof.

As the polyhydric alcohol, for example, the content of the aliphatic diol may be 80% by mole or greater and preferably 90% by mole or greater.

The melting temperature of the crystalline polyester resin is, for example, preferably 50° C. or higher and 100° C. or lower, more preferably 55° C. or higher and 90° C. or lower, and still more preferably 60° C. or higher and 85° C. or lower.

The melting temperature of the crystalline polyester resin is acquired from the DSC curve obtained by differential scanning calorimetry (DSC) according to the “melting peak temperature” described in the method of acquiring the melting temperature in JIS K 7121:1987 “Method of measuring transition temperature of plastics”.

The weight-average molecular weight (Mw) of the crystalline polyester resin is, for example, preferably 6,000 or greater and 35,000 or less.

The crystalline polyester resin can be obtained by, for example, a known production method similar to the amorphous polyester resin.

From the viewpoint that a crystal structure is easily formed and the compatibility with the amorphous polyester resin is satisfactory so that the fixability of the image is improved, for example, a polymer of α, ω-linear aliphatic dicarboxylic acid and α, ω-linear aliphatic diol is preferable as the crystalline polyester resin.

As the α, ω-linear aliphatic dicarboxylic acid, for example, α, ω-linear aliphatic dicarboxylic acid in which the number of carbon atoms of an alkylene group connecting two carboxy groups is 3 or more and 14 or less is preferable, the number of carbon atoms of the alkylene group is more preferably 4 or more and 12 or less, and the number of carbon atoms of the alkylene group is still more preferably 6 or more and 10 or less.

Examples of the α, ω-linear aliphatic dicarboxylic acid include succinic acid, glutaric acid, adipic acid, 1,6-hexanedicarboxylic acid (common name, suberic acid), 1,7-heptanedicarboxylic acid (common name, azelaic acid), 1,8-octanedicarboxylic acid (common name, sebacic acid), 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid. Among the examples, 1,6-hexanedicarboxylic acid, 1,7-heptanedicarboxylic acid, 1,8-octanedicarboxylic acid, 1,9-nonanedicarboxylic acid, or 1,10-decanedicarboxylic acid is preferable.

The α, ω-linear aliphatic dicarboxylic acid may be used alone or in combination of two or more kinds thereof.

As the α, ω-linear aliphatic diol, for example, α, ω-linear aliphatic diol in which the number of carbon atoms of an alkylene group connecting two hydroxy groups is 3 or more and 14 or less is preferable, the number of carbon atoms of the alkylene group is more preferably 4 or more and 12 or less, and the number of carbon atoms of the alkylene group is still more preferably 6 or more and 10 or less.

Examples of the α, ω-linear aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol, 1,14-tetradecanediol, and 1,18-octadecanediol. Among the examples, 1,6-hexanediol, 1,7-heptanediol, 1,8-octanediol, 1,9-nonanediol, or 1,10-decanediol is preferable.

The α, ω-linear aliphatic diol may be used alone or in combination of two or more kinds thereof.

From the viewpoint that a crystal structure is easily formed and the compatibility with the amorphous polyester resin is satisfactory so that the fixability of the image is improved, as the polymer of the α, ω-linear aliphatic dicarboxylic acid and the α, ω-linear aliphatic diol, for example, a polymer of at least one selected from the group consisting of 1,6-hexanedicarboxylic acid, 1,7-heptanedicarboxylic acid, 1,8-octanedicarboxylic acid, 1,9-nonanedicarboxylic acid, and 1,10-decanedicarboxylic acid and at least one selected from the group consisting of 1,6-hexanediol, 1,7-heptanediol, 1,8-octanediol, 1,9-nonanediol, and 1,10-decanediol is preferable. Among the examples a polymer of 1,10-decanedicarboxylic acid and 1,6-hexanediol is more preferable.

The proportion of the crystalline resin in all the binder resins is, for example, preferably 1% by mass or greater and 20% by mass or less, more preferably 2% by mass or greater and 15% by mass or less, and still more preferably 3% by mass or greater and 10% by mass or less.

### Other Binder Resins

Examples of the binder resin include homopolymers of monomers such as ethylenically unsaturated nitriles (such as acrylonitrile and methacrylnitrile), vinyl ethers (such as vinyl methyl ether and vinyl isobutyl ether), vinyl ketones (such as vinyl methyl ketone, vinyl ethyl ketone, and vinyl isopropenyl ketone), and olefins (such as ethylene, propylene, and butadiene), and copolymers obtained by combining two or more of such monomers.

Other examples of the binder resin include non-vinyl-based resins such as an epoxy resin, a polyurethane resin, a polyamide resin, a cellulose resin, a polyether resin, and modified rosin, mixtures of such resins with the above-described vinyl-based resins, and graft polymers obtained by polymerizing vinyl-based monomers in the coexistence of such resins.

The binder resins may be used alone or in combination of two or more kinds thereof.

The content of the binder resin is, for example, preferably 40% by mass or greater and 95% by mass or less, more preferably 50% by mass or greater and 90% by mass or less, and still more preferably 60% by mass or greater and 85% by mass or less with respect to the entirety of the toner particles.

### Release Agent

It is preferable that the toner particles contain, for example, a release agent.

Examples of the release agent include hydrocarbon-based wax; natural wax such as carnauba wax, rice wax, or candelilla wax; synthetic or mineral/petroleum wax such as montan wax; and ester-based wax such as fatty acid ester or montanic acid ester. The release agent is not limited thereto.

The ester wax is a wax having an ester bond. The ester-based wax may be any of a monoester, a diester, a triester, or a tetraester, and a known natural or synthetic ester wax can be employed.

Examples of the ester wax include an ester compound of a higher fatty acid (such as a fatty acid having 10 or more carbon atoms) and a monohydric or polyhydric aliphatic alcohol (such as an aliphatic alcohol having 8 or more carbon atoms), which has a melting temperature of 60° C. or higher and 110° C. or lower (for example, preferably 65° C. or higher and 100° C. or lower and more preferably 70° C. or higher and 95° C. or lower).

Examples of the ester wax include an ester compound of a higher fatty acid (caprylic acid, capric acid, lauric acid, myristic acid, palmitic acid, stearic acid, arachidic acid, behenic acid, or oleic acid) and an alcohol (a monohydric alcohol such as methanol, ethanol, propanol, isopropanol, butanol, capryl alcohol, lauryl alcohol, myristyl alcohol, cetyl alcohol, stearyl alcohol, or oleyl alcohols; or a polyhydric alcohol such as glycerin, ethylene glycol, propylene glycol, sorbitol, or pentaerythritol), and specific examples thereof include carnauba wax, rice wax, candelilla wax, jojoba oil, wood wax, beeswax, insect wax, lanolin, and montanic acid ester wax.

The melting temperature of the release agent is, for example, preferably 50° C. or higher and 110° C. or lower and more preferably 60° C. or higher and 100° C. or lower.

The melting temperature of the release agent is acquired from the DSC curve obtained by differential scanning calorimetry (DSC) according to the “melting peak temperature” described in the method of acquiring the melting temperature in JIS K7121:1987 “Method of measuring transition temperature of plastics”.

The content of the release agent is, for example, preferably 1% by mass or greater and 20% by mass or less and more preferably 2% by mass or greater and 15% by mass or less with respect to the entirety of the toner particles.

### Other Colorants

The toner A and the white toner B may contain a colorant other than the dye and the titanium oxide pigment.

Examples of other colorants include various pigments such as Carbon Black, Chrome Yellow, Hansa Yellow, Benzidine Yellow, Suren Yellow, Quinoline Yellow, Pigment Yellow, Permanent Orange GTR, Pyrazolone Orange, Vulcan Orange, Watching Red, Permanent Red, Brilliant Carmine 3B, Brilliant Carmine 6B, Dupont Oil Red, Pyrazolon Red, Lithol Red, Rhodamin B Lake, Lake Red C, Pigment Red, Rose Bengal, Aniline Blue, Ultramarine Blue, Calco Oil Blue, Methylene Blue Chloride, Phthalocyanine Blue, Pigment Blue, Phthalocyanine Green, and Malachite Green Oxalate; and various dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye.

The other colorants may be used alone or in combination of two or more kinds thereof.

As other colorants, a surface-treated colorant may be used as necessary, or a combination with a dispersant may be used. Further, a plurality of kinds of colorants may be used in combination as the other colorants.

### Other Additives

Examples of other additives include known additives such as a magnetic material, a charge control agent, and inorganic powder. The additives are contained in the toner particles as internal additives or external additives.

### Characteristics of Toner Particles and the Like

The toner particles may be toner particles having a single layer structure or may be toner particles having a so-called core-shell structure formed of a core portion (core particle) and a coating layer (shell layer) covering the core portion, but from the viewpoint of the property of suppressing fading in a high-temperature and high-humidity environment, for example, toner particles having a core-shell structure are preferable.

Here, the toner particles having a core-shell structure may be formed of, for example, a core portion containing a binder resin and, as necessary, other additives such as a colorant and a release agent, and a coating layer containing a binder resin.

The volume average particle diameter (D50v) of the toner particles is, for example, preferably 2 μm or greater and 15 μm or less, more preferably 3 μm or greater and 10 μm or less, and still more preferably 4 μm or greater and 9 μm or less.

Further, various average particle diameters and various particle size distribution indices of the toner particles are measured using Coulter Multisizer II (manufactured by Beckman Coulter Inc.) and ISOTON-II (manufactured by Beckman Coulter Inc.) as an electrolytic solution.

During the measurement, 0.5 mg or greater and 50 mg or less of a measurement sample is added to 2 ml of a 5% aqueous solution of a surfactant (for example, preferably sodium alkylbenzene sulfonate) as a dispersant. The solution is added to 100 ml or greater and 150 ml or less of the electrolytic solution.

The electrolytic solution in which the sample is suspended is subjected to a dispersion treatment for 1 minute with an ultrasonic disperser, and the particle size distribution of particles having a particle diameter in the range of 2 μm or greater and 60 μm or less is measured by a Coulter Multisizer II using an aperture with an aperture diameter of 100 pm. Further, the number of particles to be sampled is 50000.

Cumulative distribution of the volume and the number is drawn from the small diameter side for each particle size range (channel) divided based on the particle size distribution to be measured, and the particle diameter at a cumulative 16% is defined as the volume particle diameter D16v and the number particle diameter D16p, the particle diameter at a cumulative 50% is defined as the volume average particle diameter D50v and the cumulative number average particle diameter D50p, and the particle diameter at a cumulative 84% is defined as the volume particle diameter D84v and the number particle diameter D84p.

Based on the description above, the volume particle size distribution index (GSDv) is calculated as (D84v/D16v)^{1/2}, and the number particle size distribution index (GSDp) is calculated as (D84p/D16p)^{1/2}.

The average circularity of the toner particles is, for example, preferably 0.80 or greater and 1.00 or less and more preferably 0.90 or greater and 0.98 or less.

The average circularity of the toner particles is acquired by (perimeter equivalent to circle)/(perimeter)[(perimeter of circle having same projected area as particle image)/(perimeter of projected particle image)].

Specifically, the average circularity is a value measured by the following method.

First, the average circularity is acquired by a flow type particle image analyzer (FPIA-3000, manufactured by Sysmex Corporation) that sucks and collects toner particles to be measured, forms a flat flow, instantly emits strobe light so that a particle image is captured as a still image, and analyzes the particle image. Further, the number of samples in a case of calculating the average circularity is set to 3500.

Further, in a case where the toner has an external additive, the toner (developer) to be measured is dispersed in water containing a surfactant, and an ultrasonic treatment is performed, thereby obtaining toner particles from which the external additive has been removed.

### Method of Producing Toner

Next, a method of producing the toner A or the white toner B will be described.

The toner A or the white toner B is, for example, preferably obtained by externally adding an external additive to the toner particles after production of the toner particles.

The toner particles may be produced by any of a dry production method (for example, a kneading and pulverizing method) or a wet production method (for example, an aggregation and coalescence method, a suspension polymerization method, or a dissolution suspension method). The production method is not particularly limited, and a known production method is employed. Among the examples, the toner particles may be obtained by, for example, the aggregation and coalescence method.

Examples of the aggregation and coalescence method include the methods described in JP2010-97101A and JP2006-154641A.

Examples of the kneading and pulverizing method include the methods described in JP2000-267338A.

Examples of the dissolution suspension method include the methods described in JP2000-258950A.

Further, specifically, for example, in a case where the resin particles are produced by the aggregation and coalescence method, the toner particles are produced by performing a step of preparing a resin particle dispersion liquid in which resin particles serving as a binder resin are dispersed (resin particle dispersion liquid preparation step), a step of allowing the resin particles and dye particles or titanium oxide pigment particles (other particles as necessary) to be aggregated in a dispersion liquid which has been mixed with the resin particle dispersion liquid and the colorant dispersion liquid (other particle dispersion liquids as necessary) to form aggregated particles (aggregated particle formation step), and a step of heating the aggregated particle dispersion liquid in which the aggregated particles are dispersed and fusing and coalescing the aggregated particles to form resin particles (fusion and coalescence step).

As the colorant in the colorant dispersion liquid, for example, a dye and, as necessary, other colorants are preferably used in a case of the toner A, and a titanium oxide pigment is preferably used in a case of the white toner B.

The details of each step will be described below.

In the following description, a method of obtaining resin particles containing other colorants and a release agent will be described, but the other colorants and the release agent are used as necessary. It is needless to say that additives other than the other colorants and the release agent may also be used.

### Resin Particle Dispersion Liquid Preparation Step

For example, a colorant particle dispersion liquid in which the other colorant particles are dispersed and a release agent particle dispersion liquid in which the release agent particles are dispersed are prepared together with the resin particle dispersion liquid in which the resin particles serving as the binder resin are dispersed.

The resin particle dispersion liquid is prepared, for example, by allowing the resin particles to be dispersed in a dispersion medium using a surfactant.

Examples of the dispersion medium used in the resin particle dispersion liquid include an aqueous medium.

Examples of the aqueous medium include water such as distilled water or ion exchange water and alcohols. The aqueous medium may be used alone or in combination of two or more kinds thereof.

Examples of the surfactant include an anionic surfactant such as a sulfuric acid ester salt-based surfactant, a sulfonate-based surfactant, a phosphoric acid ester-based surfactant, or a soap-based surfactant, a cationic surfactant such as an amine salt type surfactant or a quaternary ammonium salt type surfactant, and a nonionic surfactant such as a polyethylene glycol-based surfactant, an alkylphenol ethylene oxide adduct-based surfactant, or a polyhydric alcohol-based surfactant. Among the examples, particularly, an anionic surfactant and a cationic surfactant may be exemplified. A nonionic surfactant may be used in combination with an anionic surfactant or a cationic surfactant.

Among the examples, for example, it is preferable to use a nonionic surfactant and more preferable to use a combination of a nonionic surfactant with an anionic surfactant or a cationic surfactant.

The surfactant may be used alone or in combination of two or more kinds thereof.

Examples of the method of allowing the resin particles to be dispersed in the dispersion medium in the resin particle dispersion liquid include typical dispersion methods such as a rotary shear homogenizer, a ball mill having a medium, a sand mill, and a dyno mill. Depending on the kind of resin particles, the resin particles may be dispersed in a dispersion medium by a phase inversion emulsification method. The phase inversion emulsification method is a method of dissolving the resin to be dispersed in a hydrophobic organic solvent in which the resin is soluble, adding a base to an organic continuous phase (O phase) for neutralization, adding an aqueous medium (W phase thereto, performing phase inversion from W/O to O/W, and dispersing the resin in the aqueous medium in the particle form.

The volume average particle diameter of the resin particles to be dispersed in the resin particle dispersion liquid is, for example, preferably 0.01 μm or greater and 1 μm or less, more preferably 0.03 μm or greater and 0.8 μm or less, and still more preferably 0.05 μm or greater and 0.6 μm or less.

The volume average particle diameter of the resin particles is obtained by drawing cumulative distribution of the volume from the small diameter side for each divided particle size range (channel) and measuring the particle diameter at a cumulative 50% as the volume average particle diameter D50v with respect to the entirety of the particles, using the particle size distribution obtained by performing measurement with a laser diffraction type particle size distribution measuring device (for example, LA-700, manufactured by Horiba, Ltd.). The volume average particle diameter of the particles in another dispersion liquid is measured in the same manner as described above.

The content of the resin particles contained in the resin particle dispersion liquid is, for example, preferably 5% by mass or greater and 50% by mass or less and more preferably 10% by mass or greater and 40% by mass or less.

Similarly to the resin particle dispersion liquid, for example, the colorant particle dispersion liquid such as a dye or a titanium oxide pigment and the release agent particle dispersion liquid are also prepared. That is, the same applies to the colorant particles to be dispersed in the colorant particle dispersion liquid and the release agent particles to be dispersed in the release agent particle dispersion liquid in terms of the volume average particle diameter of particles in the resin particle dispersion liquid, the dispersion medium, the dispersion method, and the content of the particles.

### Aggregated Particle Formation Step

Next, the resin particle dispersion liquid, the colorant particle dispersion liquid, and the release agent particle dispersion liquid are mixed.

Further, the resin particles, the colorant particles, and the release agent particles are heteroaggregated in the mixed dispersion liquid to form aggregated particles containing the resin particles, the colorant particles, and the release agent particles, which have a diameter close to the diameter of the target resin particles.

Specifically, for example, the aggregated particles are formed by adding an aggregating agent to the mixed dispersion liquid, adjusting the pH of the mixed dispersion liquid to be acidic (for example, a pH of 2 or greater and 5 or less), adding a dispersion stabilizer thereto as necessary, heating the solution to a temperature close to the glass transition temperature of the resin particles (specifically, for example, a temperature higher than or equal to the glass transition temperature of the resin particles—30° C. and lower than or equal to the glass transition temperature thereof—10° C.) and allowing the particles to be dispersed in the mixed dispersion liquid to be aggregated.

In the aggregated particle formation step, for example, the heating may be performed after the mixed dispersion liquid is stirred with a rotary shear homogenizer, the aggregating agent is added thereto at room temperature (for example, 25° C.), the pH of the mixed dispersion liquid is adjusted to be acidic (for example, a pH of 2 or greater and 5 or less), and the dispersion stabilizer is added thereto as necessary.

Examples of the aggregating agent include a surfactant having a polarity opposite to the polarity of the surfactant contained in the mixed dispersion liquid, an inorganic metal salt, and a divalent or higher valent metal complex. In a case where a metal complex is used as the aggregating agent, the amount of the surfactant to be used is reduced, and the charging characteristics are improved.

In addition to the aggregating agent, an additive that forms a complex or a bond similar to the complex with a metal ion of the aggregating agent may be used as necessary. A chelating agent is used as the additive.

Examples of the inorganic metal salt include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

As the chelating agent, a water-soluble chelating agent may also be used. Examples of the chelating agent include oxycarboxylic acids such as tartaric acid, citric acid, and gluconic acid; and aminocarboxylic acids such as iminodiacetic acid (IDA), nitrilotriacetic acid (NTA), and ethylenediaminetetraacetic acid (EDTA).

The amount of the aggregating agent to be added is, for example, preferably 0.01 parts by mass or greater and 5.0 parts by mass or less and more preferably 0.1 parts by mass or greater and less than 3.0 parts by mass with respect to 100 parts by mass of the resin particles.

### Fusion and Coalescence Step

Next, the aggregated particle dispersion liquid in which the aggregated particles are dispersed is heated to, for example, a temperature higher than or equal to the glass transition temperature of the resin particles (for example, a temperature higher than the glass transition temperature of the resin particles by 30° C. to 50° C.) and heated to a temperature higher than or equal to the melting temperature of the release agent, and the aggregated particles are fused and coalesced, thereby forming toner particles.

In the fusion and coalescence step, the resin and the release agent are in a fused state at a temperature higher than or equal to the glass transition temperature of the resin particles and higher than or equal to the melting temperature of the release agent. Thereafter, the toner particles are cooled to obtain resin particles.

As a method of adjusting the aspect ratio of the release agent in the toner particles, crystal growth is carried out by holding the release agent at a temperature around the freezing point for a certain period of time during cooling or two or more kinds of release agents having different melting temperatures are used to promote crystal growth during cooling, and thus the aspect ratio can be adjusted.

The toner particles are obtained by performing the above-described steps.

Further, the toner particles may be produced by performing a step of obtaining the aggregated particle dispersion liquid in which the aggregated particles are dispersed, further mixing the aggregated particle dispersion liquid with the resin particle dispersion liquid in which the resin particles are dispersed, and allowing the resin particles to be aggregated such that the resin particles are further attached to the surface of each aggregated particle to form second aggregated particles and a step of heating the second aggregated particle dispersion liquid in which the second aggregated particles are dispersed and fusing and coalescing the second aggregated particles to form toner particles having a core-shell structure.

After completion of the fusion and coalescence step, toner particles in a dry state are obtained by performing a known cleaning step, a known solid-liquid separation step, and a known drying step on the toner particles formed in the solution. From the viewpoint of the charging properties, for example, displacement cleaning may be sufficiently performed as the cleaning step using ion exchange water. From the viewpoint of the productivity, for example, suction filtration, pressure filtration, or the like may be performed as the solid-liquid separation step. From the viewpoint of the productivity, for example, freeze-drying, flush drying, fluidized drying, vibratory fluidized drying, or the like may be performed as the drying step.

The toner A or the white toner B is, for example, produced by adding an external additive to the obtained toner particles in a dry state and mixing the external additive with the toner particles. The mixing may be performed, for example, using a V blender, a Henschel mixer, a Lodige mixer, or the like.

Further, coarse particles of the resin particles may be removed as necessary using a vibratory sieving machine, a pneumatic sieving machine, or the like.

### Electrostatic Charge Image Developer Set

An electrostatic charge image developer set according to the present exemplary embodiment includes a first electrostatic charge image developer containing the toner A in the electrostatic charge image developing toner set according to the present exemplary embodiment, and a second electrostatic charge image developer containing the white toner B in the electrostatic charge image developing toner set according to the present exemplary embodiment.

The electrostatic charge image developer may be a one-component developer which contains only the toner or a two-component developer obtained by mixing the toner and a carrier.

The carrier is not particularly limited, and examples thereof include known carriers. Examples of the carrier include a coated carrier obtained by coating the surface of a core material consisting of magnetic powder with a coating resin, a magnetic powder dispersion type carrier obtained by dispersing magnetic powder in a matrix resin so as to be blended, and a resin impregnation type carrier obtained by impregnating porous magnetic powder with a resin.

Further, each of the magnetic powder dispersion type carrier and the resin impregnation type carrier may be a carrier obtained by coating the surface of the particle constituting the carrier, serving as a core material, with a coating resin.

Examples of the magnetic powder include magnetic metals such as iron, nickel, and cobalt and magnetic oxides such as ferrite and magnetite.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid copolymer, a straight silicone resin formed by having an organosiloxane bond or a product obtained by modifying the straight silicone resin, a fluororesin, polyester, polycarbonate, a phenol resin, and an epoxy resin.

Further, the coating resin and the matrix resin may contain other additives such as conductive particles.

Examples of the conductive particles include metals such as gold, silver, and copper, and particles such as carbon black, titanium oxide, zinc oxide, tin oxide, barium sulfate, aluminum borate, and potassium titanate.

Here, the surface of a core material is coated with a coating resin by a method of coating the surface with a solution for forming a coating layer, which is obtained by dissolving a coating resin and various additives as necessary in an appropriate solvent. The solvent is not particularly limited, and may be selected in consideration of the coating resin to be used, coating suitability, and the like.

Specific examples of the resin coating method include a dipping method of dipping the core material in the solution for forming a coating layer, a spray method of spraying the solution for forming a coating layer to the surface of the core material, a fluidized bed method of spraying the solution for forming a coating layer to the core material that is floating by an air flow, and a kneader coater method of mixing the core material of the carrier with the solution for forming a coating layer in a kneader coater and removing the solvent.

The mixing ratio (mass ratio) of the toner to the carrier (toner:carrier) in the two-component developer is, for example, preferably in a range of 1:100 to 30:100 and more preferably in a range of 3:100 to 20:100.

### Image Forming Device and Image Forming Method

An image forming device and an image forming method according to the present exemplary embodiment will be described.

The image forming device according to the present exemplary embodiment includes a first image forming unit that forms a colored image with the toner in the electrostatic charge image developing toner set according to the present exemplary embodiment, a second image forming unit that forms a white image with the white toner in the electrostatic charge image developing toner set according to the present exemplary embodiment, a transfer unit that transfers the colored image and the white image onto a recording medium, and a fixing unit that fixes the colored image and the white image onto the recording medium.

The image forming device according to the present exemplary embodiment may include, as the first and second image forming units, each image forming unit having an image holding member, a charging unit that charges the surface of the image holding member, an electrostatic charge image forming unit that forms an electrostatic charge image on the surface of the charged image holding member, and a developing unit that develops the electrostatic charge image formed on the surface of the image holding member as a toner image using the electrostatic charge image developer.

Further, the image forming device according to the present exemplary embodiment may include an image holding member, a charging unit that charges the surface of the image holding member, an electrostatic charge image forming unit that forms an electrostatic charge image on the charged surface of the image holding member, and first and second developing units that develop the electrostatic charge image formed on the surface of the image holding member using the electrostatic charge image developer as a toner image, as the first and second image forming units.

With the image forming device according to the present exemplary embodiment, an image forming method (the image forming method according to the present exemplary embodiment) including a first image forming step of forming a colored image with the toner A in the electrostatic charge image developing toner set according to the present exemplary embodiment, a second image forming step of forming a white image with the white toner B in the electrostatic charge image developing toner set according to the present exemplary embodiment, a transfer step of transferring the colored image and the white image onto a recording medium, and a fixing step of fixing the colored image and the white image onto the recording medium is performed.

As the image forming device according to the present exemplary embodiment, a known image forming device such as a direct transfer type device that directly transfers a toner image (a lustrousness image or a colored image in the present exemplary embodiment) formed on a surface of an image holding member to a recording medium, an intermediate transfer type device that primarily transfers a toner image formed on a surface of an image holding member to a surface of an intermediate transfer member and secondarily transfers the toner image transferred to the surface of the intermediate transfer member to a surface of a recording medium, a device that includes a cleaning unit cleaning a surface of an image holding member after transfer of a toner image and before charge of the image holding member, or a device that includes an electricity removing unit removing electricity by irradiating a surface of an image holding member with electricity removing light after transfer of a toner image and before charge of the image holding member is applied.

In a case where the image forming device is the intermediate transfer type device, for example, a configuration in which the transfer unit includes an intermediate transfer member having a surface onto which a toner image is transferred, a primary transfer unit primarily transferring the toner image formed on the surface of the image holding member to the surface of the intermediate transfer member, and a secondary transfer unit secondarily transferring the toner image transferred to the surface of the intermediate transfer member to the surface of the recording medium is applied.

Hereinafter, an example of the image forming device according to the present exemplary embodiment will be described, but the present exemplary embodiment is not limited thereto. In the description below, main parts shown in the figures will be described, but description of other parts will not be provided.

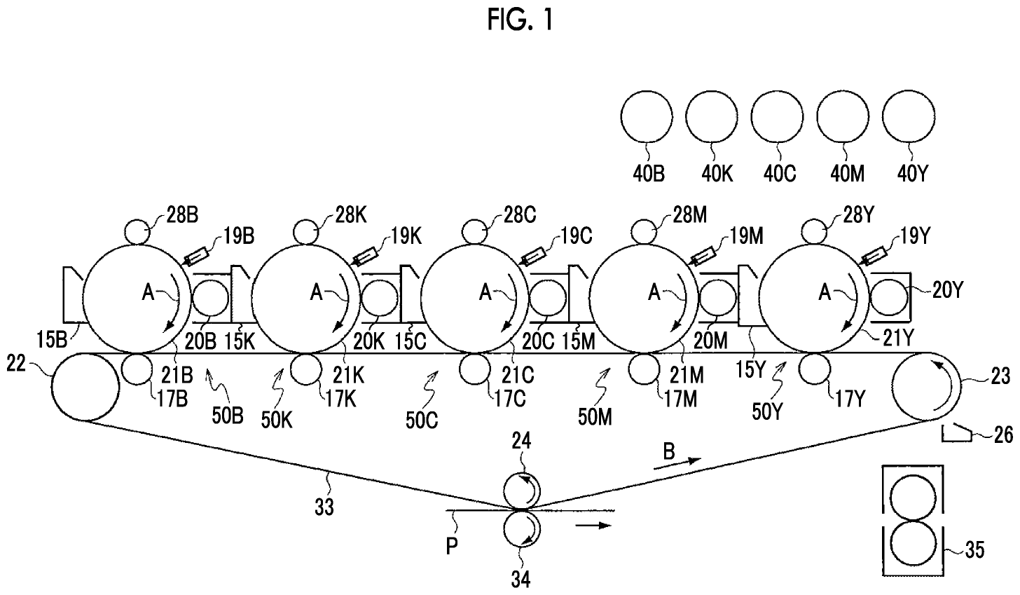

FIG. 1 is a schematic configuration view showing an image forming device according to the present exemplary embodiment and is a view showing an image forming device having a 5-series tandem system and an intermediate transfer system.

The image forming device shown in FIG. 1 includes first to fifth image forming units 50Y, 50M, 50C, 50K, and 50B (image forming units) having an electrophotographic system of outputting images of each color of yellow (Y), magenta (M), cyan (C), black (K), and white (B) based on color-separated image data. These image forming units (hereinafter, also simply referred to as “units”) 50Y, 50M, 50C, 50K, and 50B are arranged in parallel at predetermined intervals in the horizontal direction. The units 50Y, 50M, 50C, 50K, and 50B may be process cartridges detachable from the image forming device.

Above the units 50Y, 50M, 50C, 50K, and 50B, an intermediate transfer belt 33 (an example of the intermediate transfer member) extends across each of the units. An intermediate transfer belt 33 is provided by winding around a drive roll 23, a support roll 22, and an opposing roll 24 that are in contact with the inner surface of the intermediate transfer belt 33 and is designed to travel in a direction (direction indicated by the arrow B in FIG. 1) from the first unit 50Y to the fifth unit 50B. An intermediate transfer member cleaning device 26 facing the drive roll 23 is provided on the surface side of the image holding member of the intermediate transfer belt 33. Further, a voltage applying device (not shown) that generates a potential difference between the support roll 23 and the intermediate transfer belt 33 to generate an electric field therebetween is provided on the upstream side of the intermediate transfer belt 33 in the rotation direction with respect to the intermediate transfer member cleaning device 26.

Each of yellow toner, magenta toner, cyan toner, black toner, and white toner accommodated in toner cartridges 40Y, 40M, 40C, 40K, and 40B is supplied to each of developing devices (an example of developing units) 20Y, 20M, 20C, 20K, and 20B of the units 50Y, 50M, 50C, 50K, and 50B.

Since the first to fifth units 50Y, 50M, 50C, 50K, and 50B have the same configuration, operation, and effects, the first unit 50Y that forms a yellow image disposed on the upstream side in the traveling direction of the intermediate transfer belt will be described as a representative example.

The first unit 50Y includes a photoreceptor 21Y that functions as an image holding member. A charging roll (an example of the charging unit) 28Y that charges the surface of the photoreceptor 21Y at a predetermined potential, an exposure device (an example of the electrostatic charge image forming unit) 19Y that exposes the charged surface to a laser beam based on a color-separated image signal to form an electrostatic charge image, a developing device (an example of a developing unit) 20Y that supplies the toner to the electrostatic charge image to develop the electrostatic charge image, a primary transfer roll 17Y (an example of the primary transfer unit) that transfers the developed toner image onto the intermediate transfer belt 33, and a photoreceptor cleaning device (an example of the cleaning unit) 15Y that removes the toner remaining on the surface of the photoreceptor 21Y after the primary transfer are arranged in this order around the photoreceptor 21Y.

The primary transfer roll 17Y is disposed inside the intermediate transfer belt 33 and provided at a position facing the photoreceptor 21Y. Each bias power supply (not shown) that applies a primary transfer bias is connected to each of the primary transfer rolls 17Y, 17M, 17C, 17K, and 17B of the units. Each bias power supply changes the value of the transfer bias applied to each primary transfer roll by the control of a control unit (not shown).

Hereinafter, an operation of forming a yellow image in the first unit 50Y will be described.

First, prior to the operation, the surface of the photoreceptor 21Y is charged at a potential of −600 V to −800 V by the charging roll 28Y.

The photoreceptor 21Y is formed by laminating a photosensitive layer on a conductive substrate (for example, a volume resistivity of 1×10⁻⁶ Ωcm or less at 20° C.). This photosensitive layer usually has a high resistance (the resistance of a typical resin), but has a property that in a case where the photosensitive layer is irradiated with a laser beam, the specific resistance of the portion irradiated with the laser beam changes. Therefore, the exposure device 19Y irradiates the surface of the charged photoreceptor 21Y with the laser beam based on yellow image data sent from a control unit (not shown). In this manner, an electrostatic charge image in a yellow image pattern is formed on the surface of the photoreceptor 21Y.

The electrostatic charge image is an image formed on the surface of the photoreceptor 21Y by performing charging, which is a so-called negative latent image formed in a case where the specific resistance of the portion in the photosensitive layer irradiated with the laser beam is decreased by the laser beam from the exposure device 19Y, the charged electric charge on the surface of the photoreceptor 21Y flows, and the electric charge of a portion that has not been irradiated with the laser beam remains.

The electrostatic charge image formed on the photoreceptor 21Y rotates to a predetermined development position according to the traveling of the photoreceptor 21Y. Further, the electrostatic charge image on the photoreceptor 21Y is developed and visualized at this development position as a toner image by the developing device 20Y.

For example, an electrostatic charge image developer containing at least a yellow toner and a carrier is accommodated in the developing device 20Y. The yellow toner is stirred to be frictionally charged inside the developing device 20Y, has a charge having the same polarity (negative polarity) as the charged electric charge on the photoreceptor 21Y, and is held on a developer roll (an example of the developer holding member). Further, as the surface of the photoreceptor 21Y passes through the developing device 20Y, the yellow toner is electrostatically attached to the statically eliminated latent image portion on the surface of the photoreceptor 21Y, and the latent image is developed by the yellow toner. The photoreceptor 21Y on which the yellow toner image is formed is continuously traveled at a predetermined speed, and the toner image developed on the photoreceptor 21Y is transported to a predetermined primary transfer position.

In a case where the yellow toner image on the photoreceptor 21Y is transported to the primary transfer position, a primary transfer bias is applied to the primary transfer roll 17Y, and an electrostatic force from the photoreceptor 21Y toward the primary transfer roll 17Y acts on the toner image, and the toner image on the photoreceptor 21Y is transferred onto the intermediate transfer belt 33. The transfer bias applied at this time has a polarity (+) opposite to the polarity (−) of the toner and is controlled to, for example, +10 μA by a control unit (not shown) in the first unit 50Y.

On the other hand, the toner remaining on the photoreceptor 21Y is removed by the photoreceptor cleaning device 15Y and recovered.

The primary transfer bias applied to the primary transfer rolls 17M, 17C, 17K, and 17B of the second to fifth units 50M, 50C, 50K, and 50B is also controlled according to the first unit.

In this manner, the intermediate transfer belt 33 to which the yellow toner image is transferred by the first unit 50Y is sequentially transported through the second to fifth units 50M, 50C, 50K, and 50B and the toner images of each color are superimposed and multiple-transferred.

The intermediate transfer belt 3, to which the toner images of five colors are multiple-transferred through the first to fifth units, reaches a secondary transfer unit formed of the intermediate transfer belt 33, an opposing roll 24 in contact with the inner surface of the intermediate transfer belt 33, and a secondary transfer roll (an example of the secondary transfer unit) 34 disposed on the surface side of the image holding member of the intermediate transfer belt 33. On the other hand, recording paper (an example of the recording medium) P is supplied to a gap where the secondary transfer roll 34 is in contact with the intermediate transfer belt 33 via a supply mechanism, at a predetermined timing, and a secondary transfer bias is applied to the opposing roll 24. The transfer bias applied at this time has the same polarity (−) as the polarity (−) of the toner, and the electrostatic force from the intermediate transfer belt 33 toward the recording paper P acts on the toner image so that the toner image on the intermediate transfer belt 33 is transferred onto the recording paper P. The secondary transfer bias at this time is determined according to the resistance detected by a resistance detector (not shown) that detects the resistance of the secondary transfer unit, and the voltage is controlled.

Thereafter, the recording paper P is sent to a pressure welding portion (nip portion) of a pair of fixing rolls in a fixing device (an example of the fixing unit) 35, and the toner image is fixed onto the recording paper P to form the fixed image.

Examples of the recording paper P that transfers the toner image include plain paper used in electrophotographic copying machines, printers, and the like. Examples of the recording medium include an OHP sheet in addition to the recording paper P.

In order to further improve the smoothness of the image surface after the fixation, for example, it is preferable that the surface of the recording paper P is also smooth. For example, coated paper in which the surface of plain paper is coated with a resin or the like, art paper for printing, or the like is preferably used.

The recording paper P in which the fixation of the color images is completed is transported toward a discharge unit, and a series of color image forming operations is completed.

The image forming device shown in FIG. 1 is an image forming device having a configuration in which the toner cartridges 40Y, 40M, 40C, 40K, and 40B are detachable, and the developing devices 20Y, 20M, 20C, 20K, and 20B are respectively connected to the toner cartridge corresponding to each developing device (color) through a toner supply tube (not shown). Further, in a case where the amount of toner accommodated in the container of the toner cartridge is decreased, the toner cartridge is replaced.

### Process Cartridge/Toner Cartridge

The process cartridge according to the present exemplary embodiment will be described.

The process cartridge according to the present exemplary embodiment includes a first developing unit that includes a container accommodating the first electrostatic charge image developer in the electrostatic charge image developer set according to the present exemplary embodiment, and a second developing unit that includes a container accommodating the second electrostatic charge image developer in the electrostatic charge image developer set according to the present exemplary embodiment, and the process cartridge is detachable from the image forming device.

The configuration of the process cartridge according to the present exemplary embodiment is not limited thereto, and a configuration including a developing device and, as necessary, at least one selected from other units such as an image holding member, a charging unit, an electrostatic charge image forming unit, and a transfer unit may be employed.

Hereinafter, an example of the process cartridge according to the present exemplary embodiment will be described, but the present invention is not limited thereto. Further, main parts shown in the figures will be described, but description of other parts will not be provided.

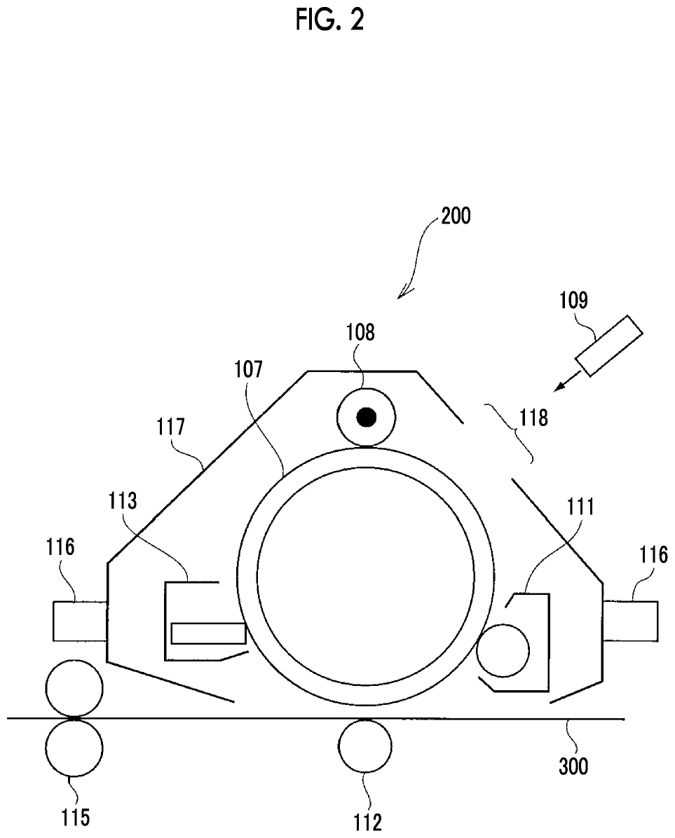

FIG. 2 is a schematic configuration view showing the process cartridge according to the present exemplary embodiment.

A process cartridge 200 shown in FIG. 2 is, for example, configured such that a photoreceptor 107 (an example of the image holding member), a charging roll 108 (an example of the charging unit) provided in the periphery of the photoreceptor 107, a developing device 111 (an example of the developing unit), and a photoreceptor cleaning device 113 (an example of the cleaning unit) are integrally combined and held by a housing 117 provided with a mounting rail 116 and an opening portion 118 for exposure to form a cartridge.

In FIG. 2, the reference numeral 109 represents an exposure device (an example of the electrostatic charge image forming unit), the reference numeral 112 represents a primary transfer roll (an example of the primary transfer unit), the reference numeral 120 is an intermediate transfer belt (an example of the intermediate transfer member), the reference numeral 122 represents a drive roll that also serves as an intermediate transfer belt electricity removing unit (an example of the intermediate transfer member electricity removing unit), the reference numeral 124 represents a support roll, the reference numeral 126 represents a secondary transfer roll (an example of the secondary transfer unit, the reference numeral 128 represents a fixing device (an example of the fixing unit), and the reference numeral 300 represents a recording paper (an examples of the recording medium).

The toner cartridge according to the present exemplary embodiment will be described below.

The toner cartridge set according to the present exemplary embodiment is a toner cartridge set including a first toner cartridge that includes a container accommodating the toner A in the electrostatic charge image developing toner set according to the present exemplary embodiment, and a second toner cartridge that includes a container accommodating the white toner B in the electrostatic charge image developing toner set according to the present exemplary embodiment, and the toner cartridge is detachable from the image forming device.

Each toner cartridge includes a container accommodating a toner for replenishment which is to be supplied to the developing unit provided in the image forming device.

### EXAMPLES

Hereinafter, the present exemplary embodiment will be described in more detail with reference to examples and comparative examples, but the present exemplary embodiment is not limited to such examples. In addition, “part” and “%” showing an amount are on a mass basis unless otherwise specified.

Further, compounds represented by Formulae (I-1) to (I-23), (II-1) to (II-85), and c1 to c13 in examples are respective the same as the compounds represented by Formulae (I-1) to (I-23), (II-1) to (II-85), and c1 to c13.

### Production of Toner A1

### Preparation of Dye Particle Dispersion Liquid

Pyrazolotriazole-based dye 1-3: 15.8 parts

Acetylacetone metal compound 11-34: 34.2 parts

Anionic surfactant (NEOGEN RK, manufactured by DKS Co., Ltd.): 5 parts

Ion exchange water: 193 parts

The above-described components are mixed and treated with an ULTIMAIZER (manufactured by Sugino Machine Limited Co., Ltd.) at 240 MPa for 10 minutes to prepare a colorant particle dispersion liquid (concentration of solid contents: 20%).

A pyrazolotriazole-based dye I-3 and an acetylacetone metal compound II-34 are compounds shown below.

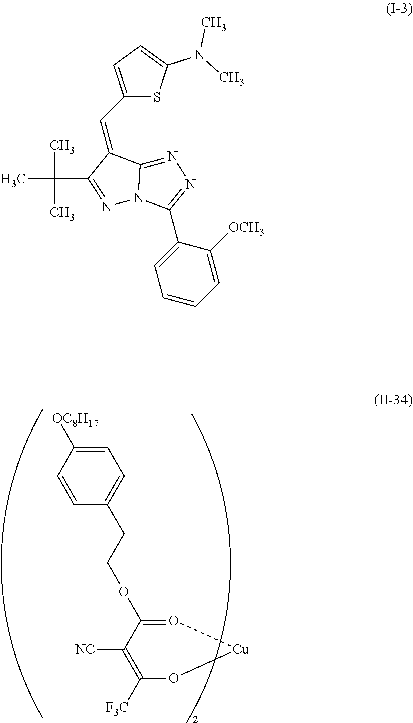

### Preparation of Styrene Acrylic Resin Particle Dispersion Liquid (1)

### Preparation of styrene acrylic resin particle dispersion liquid

### Materials for Oil Phase

Styrene (manufactured by Fujifilm Wako Pure Chemical Corporation): 30 parts

n-Butyl acrylate (manufactured by Fujifilm Wako Pure Chemical Corporation): 10 parts

β-carboxyethyl acrylate (manufactured by Rhodia Nicca, Ltd.): 1.3 parts

Dodecanethiol (manufactured by Fujifilm Wako Pure Chemical Corporation): 0.4 parts

### Materials for Aqueous Phase 1

Ion exchange water: 17 parts

Anionic surfactant: DOWFAX (manufactured by Dow Chemical Company): 0.4 parts

### Materials for Aqueous Phase 2

Ion exchange water: 40 parts

Anionic surfactant: DOWFAX (manufactured by Dow Chemical Company): 0.05 parts

Ammonium peroxodisulfate (manufactured by Fujifilm Wako Pure Chemical Corporation): 0.4 parts

The materials for the oil phase and the materials for the aqueous phase 1 are respectively mixed and stirred, and all the materials are mixed and stirred to obtain an emulsified dispersion liquid of the monomer. Separately, the materials for the aqueous phase 2 are put into a reaction container, the inside of the reaction container is sufficiently substituted with nitrogen, and the inside of the reaction system is heated to 75° C. in an oil bath while the mixture is being stirred. The monomer emulsified dispersion liquid is gradually added dropwise to the reaction container over 3 hours to perform emulsion polymerization. After completion of the dropwise addition, the polymerization is further continued at 75° C. and stopped after 3 hours, thereby obtaining a styrene acrylic resin particle dispersion liquid having a solid content of 42% by mass. The amount of the solid content is adjusted to 20% by adding ion exchange water to the resin particle dispersion liquid, thereby obtaining a styrene acrylic resin particle dispersion liquid (1).

The volume average particle diameter is measured with a particle size distribution measuring device (LA-700 manufactured by HORIBA, Ltd.), and the diameter is 250 nm. The glass transition temperature of the resin is measured at a temperature increasing rate of 10° C./min with a differential scanning calorimeter (DSC-50, manufactured by Shimadzu Corporation), and the temperature is 52° C. The number average molecular weight (in terms of polystyrene) is measured according to GPC, and the value is 13,000.

### Preparation of Release Agent Particle Dispersion Liquid (1)

Paraffin wax (HNP-9, manufactured by Nippon Seiro Co., Ltd.): 100 parts

Anionic surfactant (NEOGEN RK, manufactured by DKS Co., Ltd.): 1 part

Ion exchange water: 350 parts

The above-described materials are mixed, heated to 100° C., dispersed using a homogenizer (ULTRA-TURRAX T50, manufactured by IKA), and subjected to a dispersion treatment using a Manton Gaulin high-pressure homogenizer (manufactured by Gaulin), thereby obtaining a release agent particle dispersion liquid (1) (solid content of 20% by mass) in which release agent particles having a volume average particle diameter of 200 nm are dispersed.

### Preparation of Toner Particles (A1)

Styrene acrylic resin particle dispersion liquid (1) : 390 parts

Dye particle dispersion liquid (1): 20 parts

Release agent particle dispersion liquid (1): 40 parts

Anionic surfactant (NEOGEN RK, manufactured by DKS Co., Ltd., 20%): 1 part

The above-described materials are added to a round stainless steel flask, the pH of the mixture is adjusted to 3.5 by adding 0.1 N (=mol/L) nitric acid, and 30 parts of a nitric acid aqueous solution having a polyaluminum chloride concentration of 10% by mass is added to the mixture. After a homogenizer (trade name, ULTRA-TURRAX T50, manufactured by IKA) is used for dispersion at a liquid temperature of 30° C., the solution is heated to 45° C. in a heating oil bath and maintained for 30 minutes. Thereafter, 200 parts of the styrene acrylic resin particle dispersion liquid (1) is added to the solution and maintained for 1 hour, a 0.1 N sodium hydroxide aqueous solution is added thereto to adjust the pH of the solution to 8.5, and the solution is heated to 85° C. and maintained for 2.5 hours. Next, the solution is cooled to 20° C. at a rate of 20° C./min, the solid content is separated by filtration, sufficiently washed with ion exchange water, and dried, thereby obtaining toner particles (A1). The volume average particle diameter of the toner particles (A1) is 7 μm.

### Preparation of Carrier 1

Ferrite particles (average particle diameter of 35 μm) : 100 parts

Toluene: 14 parts

Polymethylmethacrylate (MMA, weight-average-molecular weight of 75,000): 5 parts

Carbon black: 0.2 parts (VXC-72, manufactured by Cabot Corporation, volume resistivity: 100 Ωcm or less)

A dispersion liquid obtained by dispersing the above-described materials except for ferrite particles in a sand mill is prepared, the dispersion liquid and the ferrite particles are added to a vacuum degassing type kneader and dried under reduced pressure while being stirred, thereby obtaining a carrier 1.

### Preparation of Toner A1

1.5 parts by mass of hydrophobic silica (RY50, manufactured by Nippon Aerosil Co., Ltd.) and 1.0 parts by mass of hydrophobic titanium oxide (T805, manufactured by Nippon Aerosil Co., Ltd.) with respect to 100 parts by mass of the obtained toner particles (A1) are mixed and blended at 10,000 rpm (revolutions per minute) for 30 seconds using a sample mill. Thereafter, the toner A1 (electrostatic charge image developing toner) is prepared by sieving the mixture with a vibrating sieve having a mesh opening of 45 pm. The volume average particle diameter of the obtained toner A1 is 7 μm.

Preparation of electrostatic charge image developer

8 parts of the toner A1 and 92 parts of the carrier are mixed in a V blender, thereby preparing a developer A1 (electrostatic charge image developer).

### Preparation of White Toner B1

### Preparation of White Pigment Dispersion Liquid (1)

Titanium oxide (CR-60-2, manufactured by Ishihara Sangyo Kaisha, Ltd., number average particle diameter of 210 nm): 100 parts

Nonionic surfactant (NONIPOL 400, manufactured by Sanyo Chemical Industries, Ltd.): 10 parts

Ion exchange water: 400 parts

The above-described components are mixed, stirred using a homogenizer (ULTRA-TURRAX T50, manufactured by IKA) for 30 minutes, and subjected to a dispersion treatment in a high-pressure impact disperser ULTIMAIZER (HJP30006: manufactured by Sugino Machine, Ltd.) for 1 hour, thereby preparing a white pigment dispersion liquid (1) (concentration of solid contents: 20%).

### Synthesis of Amorphous PolyesterRresin (1)

Bisphenol A ethylene oxide adduct (2.2 mol addiction): 40% by mole

Bisphenol A propylene oxide adduct (2.2 mol addiction): 60% by mole

Terephthalic acid: 47% by mole

Fumaric acid: 40% by mole

Dodecenyl succinic anhydride: 15% by mole

Trimellitic anhydride: 3% by mole

0.25 parts of tin dioctanoate with respect to 100 parts of the total amount of the monomer components together with the monomer components excluding fumaric acid and a trimellitic anhydride are put into a reaction container equipped with a stirrer, a thermometer, a condenser, and a nitrogen gas introduction tube. The mixture is allowed to react at 235° C. for 6 hours in a nitrogen gas stream and cooled to 200° C., the fumaric acid and the trimellitic acid anhydride are added to the mixture, and the mixture is allowed to react for 1 hour. The temperature is further increased to 220° C. over 4 hours and the mixture is polymerized under a pressure of 10 kPa until the molecular weight reaches a desired value, thereby obtaining a pale yellow transparent amorphous polyester resin.

As the measurement results for the obtained amorphous polyester resin (1), the glass transition temperature Tg measured by DSC is 59° C., the weight-average-molecular weight Mw measured by GPC is 25,000, the number average molecular weight Mn is 7,000, the softening temperature measured by a flow tester is 107° C., and the acid value AV is 13 mgKOH/g.

### Preparation of Amorphous Polyester Resin Dispersion Liquid (1)

While a reaction vessel equipped with a jacket (BJ-30N, manufactured by Tokyo Rikakikai Co., Ltd.) including a condenser, a thermometer, a water dripping device, and an anchor blade is maintained at 40° C. in a water circulation type constant temperature vessel, a mixed solution of 160 parts of ethyl acetate and 100 parts of isopropyl alcohol is put into the reaction vessel, 300 parts of the amorphous polyester resin (1) is put into the reaction vessel, and the solution is stirred at 150 rpm using a three-one motor for dissolution, thereby obtaining an oil phase. 14 parts of a 10% ammonia aqueous solution is added dropwise to the oil phase while being stirred for a dripping time of 5 minutes and mixed for 10 minutes, and 900 parts of ion exchange water is further added thereto at a rate of 7 parts/min to invert the phase, thereby obtaining an emulsified liquid.

800 parts of the obtained emulsified liquid and 700 parts of ion exchange water are added to an eggplant flask, and the flask is set in an evaporator (manufactured by Tokyo Rikakikai Co., Ltd.) equipped with a vacuum control unit via a trap ball. The eggplant flask is heated in a hot water bath at 60° C. while rotating and decompressed to 7 kPa while paying attention to sudden boiling to remove the solvent. The pressure is returned to normal pressure at the time point at which the solvent recovery amount reached 1,100 parts, and the eggplant flask is water-cooled to obtain a dispersion liquid. The obtained dispersion liquid has no solvent odor. The volume average particle diameter of the resin particles in this dispersion liquid is 130 nm.

Thereafter, ion exchange water is added to adjust the concentration of solid contents to 20%, and the resultant is used as an amorphous polyester resin dispersion liquid (1).

### Preparation of Amorphous Polyester Resin Particle Dispersion Liquid (2)

An amorphous polyester resin dispersion liquid (2) is prepared in the same manner as that for the amorphous polyester resin dispersion liquid (1) except that the monomer components in the synthesis of the amorphous polyester resin (1) are replaced with the following components.

Bisphenol A ethylene oxide adduct (2.2 mol addiction): 5% by mole

Bisphenol A propylene oxide adduct (2.2 mol addiction): 95% by mole

Terephthalic acid: 77% by mole

Fumaric acid: 10% by mole

Dodecenyl succinic anhydride: 10% by mole

Trimellitic anhydride: 2% by mole Synthesis of crystalline polyester resin (1)

1,10-dodecane diacid: 50% by mole

1,9-Nonanediol: 50% by mole

The monomer components are added to a reaction container equipped with a stirrer, a thermometer, a condenser, and a nitrogen gas introduction tube, the inside of the reaction container is substituted with dry nitrogen gas, and 0.25 parts of titanium tetrabutoxide (reagent) is added to 100 parts of the monomer components. The mixture is stirred and allowed to react at 170° C. for 3 hours in a nitrogen gas stream and further heated to a temperature of 210° C. for 1 hour, the pressure inside the reaction container is reduced to 3 kPa, and the mixture is stirred and allowed to react under reduced pressure for 13 hours, thereby obtaining a crystalline polyester resin (1).

As the measurement results of the obtained crystalline polyester resin (1), the melting temperature is 73.6° C. measured by DSC, the mass average molecular weight Mw is 25,000 measured by GPC, the number average molecular weight Mn is 10,500, and the acid value AV is 10.1 mgKOH/g.

### Preparation of Crystalline Polyester Resin Dispersion Liquid (1)

300 parts of the crystalline polyester resin (1), 160 parts of methyl ethyl ketone (solvent), and 100 parts of isopropyl alcohol (solvent) are added to a reaction vessel equipped with a jacket (BJ-30N, manufactured by Tokyo Rikakikai Co., Ltd.) including a condenser, a thermometer, a water dripping device, and an anchor blade and mixed by being stirred at 100 rpm while being maintained at 70° C. in a water circulation type constant temperature vessel so that the resin is dissolved.

Thereafter, the stirring rotation speed is set to 150 rpm, the temperature of the water circulation type constant temperature vessel is set to 66° C., 17 parts of 10% ammonia water (reagent) is added to the vessel over 10 minutes, and a total of 900 parts of ion exchange water which has been warmed to 66° C. is added dropwise to the solution at a rate of 7 parts/min for phase inversion, thereby obtaining an emulsified liquid.

800 parts of the obtained emulsified liquid and 700 parts of ion exchange water are added to an eggplant flask, and the flask is set in an evaporator (manufactured by Tokyo Rikakikai Co., Ltd.) equipped with a vacuum control unit via a trap ball. The eggplant flask is heated in a hot water bath at 60° C. while rotating and decompressed to 7 kPa while paying attention to sudden boiling to remove the solvent. The pressure is returned to normal pressure at the time point at which the solvent recovery amount reached 1,100 parts, and the eggplant flask is water-cooled to obtain a dispersion liquid. The obtained dispersion liquid has no solvent odor. The volume average particle diameter of the resin particles in this dispersion liquid is 130 nm. Thereafter, ion exchange water is added to adjust the concentration of solid contents to 20%, and the resultant is used as a crystalline polyester resin dispersion liquid (1).

### Toner Particles (B1)

250 parts of the amorphous polyester resin dispersion liquid (1), 100 parts of the crystalline polyester resin dispersion liquid (1), 300 parts the white pigment dispersion liquid (1), 50 parts of the release agent dispersion liquid (1), and 4 parts of the anionic surfactant (TaycaPower, manufactured by Tyaca Corporation) are added to a round stainless steel flask, 0.1 N nitric acid is added thereto to adjust the pH of the solution to 4.0, and 0.2 parts of a nitric acid aqueous solution having a polyaluminum chloride concentration of 10% is added thereto. Thereafter, the above-described materials are dispersed at 30° C. for 5 minutes using a homogenizer (ULTRA-TURRAX T50, manufactured by IKA).

Next, the solution is heated to 45° C. in a heating oil bath and maintained for 30 minutes. Thereafter, 100 parts of the amorphous polyester resin dispersion liquid (1) is added thereto and maintained for 1 hour, a 0.1 N (=0.1 mol/L) sodium hydroxide aqueous solution is added thereto to adjust the pH of the solution to 8.5, and the solution is heated to 73° C. while being continuously stirred and is maintained for 5 hours. Next, the solution is cooled to 20° C. at a rate of 20° C./min, filtered, sufficiently washed with ion exchange water, and dried, thereby obtaining toner particles (B1) having a volume average particle diameter of 8 μm.

### Preparation of White Toner B1

100 parts of the toner particles (B1) and 0.7 parts of dimethyl silicone oil-treated silica particles (RY200, manufactured by Nippon Aerosil Co., Ltd.) are mixed using a Henschel mixer, thereby obtaining a white toner B1 (electrostatic charge image developing toner).

### Preparation of Electrostatic Charge Image Developer

Ferrite particles (average particle diameter of 50 μm) : 100 parts

Toluene: 14 parts

Styrene/methyl methacrylate copolymer (copolymerization ratio of 15/85): 3 parts

Carbon black: 0.2 copies

A dispersion liquid obtained by dispersing the above-described components except for ferrite particles in a sand mill is prepared, the dispersion liquid and the ferrite particles are added to a vacuum degassing type kneader and dried under reduced pressure while being stirred, thereby obtaining a carrier B.

Next, 8 parts of the toner B1 is mixed with 100 parts of the carrier B, thereby obtaining a developer B1 (electrostatic charge image developer).

The following evaluation is performed using the obtained developer set of the developer A1 and the developer B1.

The following operation, image formation, and measurement are performed in an environment of a temperature of 35° C. (±5° C.) and a humidity of 70%.

Two devices of DocuCentre Color 400 CP (manufactured by Fujifilm Business Innovation Corp.) are prepared as image forming devices for forming images for evaluation. The first is used for forming background images with the white toner B, and the developer is put into the developing device and the toner is put into the toner cartridge at the position of the K engine in each example and each comparative example. The second device is used for forming YMCK color images with the toner A, and the developer is put into the developing device and the toner is put into the toner cartridge at the engine position corresponding to each example and each comparative example.

### Evaluation of Property of Suppressing Fading in High-Temperature and High-Humidity Environment

An image of the white toner B single color with a density of 100% (full surface solid image, amount of toner used: 12 g/m²) is formed on the lower layer of OHP film clear A4 for a PPC laser (manufactured by Fujifilm Business Innovation Corp.), and an image of the toner A single color with a density of 100% (size: 5 cm×5 cm, amount of toner used: 5 g/m²) is formed on the upper layer of OHP film clear A4.

The formed images are irradiated with ultraviolet rays (illuminance of 99,000 lux) for 50 hours in an environment of a temperature of 35° C. (±5° C.) and a humidity of 70% using an accelerated weathering tester (Ci4000 manufactured by ATLAS).

The solid image density SAD (1) before the irradiation with ultraviolet rays and the solid image density SAD (2) before the irradiation with ultraviolet rays are measured using an X-Rite spectrophotometer 939 (manufactured by X-Rite), and the density residual ratio SAD (2)/SAD (1) is calculated for the value of C in a case of the cyan toner, the value of M in a case of the magenta toner, the value of Y in a case of the yellow toner, and the value of K in a case of the black toner.

Thereafter, the property of suppressing fading in a high-temperature and high-humidity environment The results are listed in Table 2.

### Evaluation Standards

AA: The density residual ratio SAD (2)/SAD (1) is 90% or greater and 100% or less

A: The density residual ratio SAD (2)/SAD (1) is 80% or greater and less than 90%

B: The density residual ratio SAD (2)/SAD (1) is 70% or greater and less than 80%

C: The density residual ratio SAD (2)/SAD (1) is 60% or greater and less than 70%

D: The density residual ratio SAD (2)/SAD (1) is 50% or greater and less than 60%

E: The density residual ratio SAD (2)/SAD (1) is 30% or greater and less than 50%

F: The density residual ratio SAD (2)/SAD (1) is 10% or greater and less than 30%

G: The density residual ratio SAD (2)/SAD (1) is less than 10%

### Halftone Reproducibility Evaluation

In the same environment as in the evaluation of the property of suppressing fading in a high-temperature and high-humidity environment, an image of the white toner B single color with a density of 100% (full surface solid image, amount of toner used: 12 g/m²) is output to the lower layer of OHP film clear A4 for a PPC laser (manufactured by Fujifilm Business Innovation Corp.), and the Electrophotography Society Test Chart No. 5-1 is output to the upper layer of OHP film clear A4 with the toner A by using two identical machines.

Thereafter, the coordinate values (the L* value, the a* value, and the b* value) of the CIE 1976 L*a*b* color system are acquired for ten sites of the +0.1 multi-order color halftone image area in the output image without irradiation with ultraviolet rays by the accelerated weathering tester, using X-Rite 939 (aperture diameter of 4 mm, manufactured by X-Rite, Inc.). The color difference ΔE is calculated using the obtained coordinate values. Thereafter, the halftone reproducibility in a high-temperature and high-humidity environment is evaluated according to the following evaluation standards. The results are listed in Table 2.

[symbol]

[symbol]

[symbol]

[symbol]

L₁, a₁, and b₁ represent the L* value, the a* value, and the b* value obtained by measuring the output images of each example and each comparative example using X-Rite 939, and L₂, a₂, and b₂ represent the L* value, the a* value, and the b* value obtained by measuring the test chart of Journal of the Imaging Society of Japan (the Electrophotographic Society Test Chart No. 5-1) using X-Rite939.

### Evaluation Standards

A: A difference between the maximum value and the minimum value of ΔE at ten sites is less than 1.0.

B: A difference between the maximum value and the minimum value of ΔE at ten sites is 1.0 or greater and less than 2.0.

C: A difference between the maximum value and the minimum value of ΔE at ten sites is 2.0 or greater.

### Example 2

The toner A, the white toner B, and the electrostatic charge image developers are prepared in the same manner as in Example 1 except that 60 parts of 390 parts of the styrene acrylic resin particle dispersion liquid (1) that is initially added to a round stainless steel flask is changed to the amorphous polyester resin particle dispersion liquid (1) in the preparation of the toner particles (A1) and 120 parts of 250 parts of the amorphous polyester resin dispersion liquid (1) that is initially added to a round stainless steel flask is changed to the styrene acrylic resin particle dispersion liquid (1) in the preparation of the toner particles (B1).

### Example 3

The toner A, the white toner B, and the electrostatic charge image developers are prepared in the same manner as in Example 1 except that 250 parts of the amorphous polyester resin dispersion liquid (1) that is initially added to a round stainless steel flask is replaced with 250 parts of the amorphous polyester resin dispersion liquid (2) and 30 parts of 50 parts of the release agent dispersion liquid (1) is replaced with the amorphous polyester resin dispersion liquid (2) in the preparation of the toner particles (B1), as the preparation of the toner particles (B3), and the evaluation is performed.

### Example 4

The toner A, the white toner B, and the electrostatic charge image developers are prepared in the same manner as in Example 3 except that 60 parts of 250 parts of the amorphous polyester resin dispersion liquid (2) that is initially added to a round stainless steel flask is replaced with the release agent dispersion liquid (1) in the preparation of the toner particles (B3), and the evaluation is performed.

### Example 5

The toner A, the white toner B, and the electrostatic charge image developers are prepared in the same manner as in Example 1 except that the white toner B is prepared by the following kneading and pulverizing method.

### Preparation of Toner Particles/Kneading and Pulverizing Method

A mixture of 44 parts of the amorphous polyester resin (1), 13 parts of the crystalline polyester resin (1), 38 parts of titanium oxide (CR-60-2, manufactured by Ishihara Sangyo Kaisha, Ltd.), and 5 parts of paraffin wax (HNP-9, HNP-9, manufactured by Nippon Seiro Co., Ltd.) is premixed with a 75 L Henschel mixer and kneaded under the following conditions with a twin-screw continuous kneader having a screw configuration, thereby obtaining a kneaded product. Specifically, the kneading is performed under the conditions of a kneading temperature of 160° C., a rotation speed of 280 rpm, and a kneading speed of 90 kg/h.

The obtained kneaded product is pulverized using a 400AFG-CR pulverizer (manufactured by Hosokawa Micron Corporation), and the fine powder and coarse powder are removed using a pneumatic elbow jet classifier (manufactured by Matsubo Corporation), thereby obtaining toner particles. Next, the toner particles are heated (post-annealed) under the condition of 73° C. for 120 minutes, thereby obtaining toner particles (B5) having a volume average particle diameter of 15 μm.

100 parts of the toner particles (B5) and 0.7 parts of dimethyl silicone oil-treated silica particles (RY200, manufactured by Nippon Aerosil Co., Ltd.) are mixed using a Henschel mixer, thereby obtaining a white toner B5 (electrostatic charge image developing toner).

A developer B5 is obtained by preparing a toner in the same manner as in Example 1 except that the white toner particles B5 are used.

### Example 6

The toner A, the white toner B, and the electrostatic charge image developers are prepared in the same manner as in Example 1 except that the pyrazolotriazole-based dye I-3 is changed to the phthalocyanine-based dye cl in the preparation of the toner A.

The phthalocyanine-based dye cl is a compound shown below.

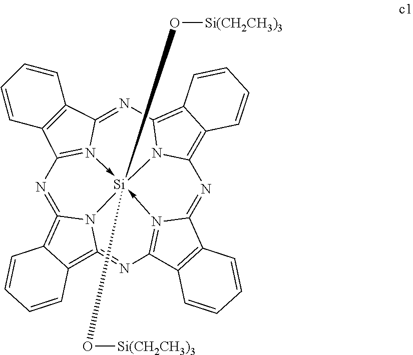

### Example 7

The toner A, the white toner B, and the electrostatic charge image developers are prepared in the same manner as in Example 1 except that the pyrazolotriazole-based dye I-3 is changed to Basic Red 1 in the preparation of the toner A.

### Example 8

The toner A, the white toner B, and the electrostatic charge image developers are prepared in the same manner as in Example 1 except that the amount of acetylacetone metal compound II-34 is changed from 34.2 parts to 30 parts, the amount of the anionic surfactant (NEOGEN RK, manufactured by DKS Co., Ltd.) is changed from 5 parts to 8 parts, and the treatment time of ULTIMAIZER (manufactured by Sugino Machine, Ltd.) is changed to 15 minutes in the preparation of the dye particle dispersion liquid of the toner A, and the evaluation is performed.

### Example 9

The toner A, the white toner B, and the electrostatic charge image developers are prepared in the same manner as in Example 1 except that the treatment time of ULTIMAIZER (manufactured by Sugino Machine, Ltd.) is changed to 2 minutes in the preparation of the dye particle dispersion liquid of the toner A, and the evaluation is performed.

### Example 10

The toner A, the white toner B, and the electrostatic charge image developers are prepared in the same manner as in Example 1 except that the entire styrene acrylic resin particle dispersion liquid (1) is changed to the amorphous polyester resin particle dispersion liquid (1) in the preparation of the toner particles (A1), and the entire amorphous polyester resin dispersion liquid (1) and the entire crystalline polyester resin dispersion liquid (1) are changed to the styrene acrylic resin particle dispersion liquid (1) in the preparation of the toner particles (B1), and the evaluation is performed.

### Comparative Example 1

The toner A, the white toner B, and the electrostatic charge image developers are prepared in the same manner as in Example 1 except that the entire amorphous polyester resin dispersion liquid (1) and the entire crystalline polyester resin dispersion liquid (1) are replaced with the styrene acrylic resin particle dispersion liquid (1) in the preparation of the toner particles (B1), and the evaluation is performed.

### Comparative Example 2

The toner A, the white toner B, and the electrostatic charge image developers are prepared in the same manner as in Example 1 except that 210 parts of 390 parts of the styrene acrylic resin particle dispersion liquid (1) that is initially added to a round stainless steel flask is changed to the amorphous polyester resin particle dispersion liquid (1) in the preparation of the toner particles (A1) and 180 parts of 250 parts of the amorphous polyester resin dispersion liquid (1) that is initially added to a round stainless steel flask is changed to the styrene acrylic resin particle dispersion liquid (1) in the preparation of the toner particles (B1), and the evaluation is performed.

TABLE 2

| | | | | | | White toner B | | | |
|---|---|---|---|---|---|---|---|---|---|
| | Toner A | | | | | Number average | | | |
| | | Binder resin A | | | | particle diameter | Binder resin B | | |
| | | | Solubility | | | of part where dye | | Solubility | |
| | | | parameter | | | is dispersed in | | parameter | Titanium oxide |
| | | | SP value | Dye | | toner in particle | | SP value | particles |
| | No. | Type | (SPA) | Type | Number | form (nm) | No. | (SPA) | Type |
| Example1 | A1 | St/Ac | 9.2 | Pyrazolotriazole- | 30 | B1 | Pes | 10.6 | CR-60-2 |
| | (Magenta | | | based dye I-3 | | | | | |
| | toner) | | | | | | | | |
| Example2 | A2 | St/Ac + | 9.4 | Pyrazolotriazole- | 30 | B2 | Pes + | 9.9 | CR-60-2 |
| | (Magenta | Pes | | based dye I-3 | | | St/Ac | | |
| | toner) | | | | | | | | |
| Example3 | A3 | St/Ac | 9.2 | Pyrazolotriazole- | 30 | B3 | Pes | 12.2 | CR-60-2 |
| | (Magenta | | | based dye I-3 | | | | | |
| | toner) | | | | | | | | |
| Example4 | A4 | St/Ac | 8.2 | Pyrazolotriazole- | 30 | B3 | Pes | 12.2 | CR-60-2 |
| | (Magenta | | | based dye I-3 | | | | | |
| | toner) | | | | | | | | |
| Example5 | A3 | St/Ac | 9.2 | Pyrazolotriazole- | 30 | B5 | Pes | 10.6 | CR-60-2 |
| | (Magenta | | | based dye I-3 | | | | | |
| | toner) | | | | | | | | |
| Example6 | A6 | St/Ac | 9.2 | Phthalocyanine- | 100 | B1 | Pes | 10.6 | CR-60-2 |
| | (Magenta | | | based dye c1 | | | | | |
| | toner) | | | | | | | | |
| Example7 | A7 | St/Ac | 9.4 | Basic Red 1 | 30 | B1 | Pes | 10.6 | CR-60-2 |
| | (Magenta | | | | | | | | |
| | toner) | | | | | | | | |
| Example8 | A8 | St/Ac | 9.2 | Pyrazolotriazole- | 10 | B1 | Pes | 10.6 | CR-60-2 |
| | (Magenta | | | based dye I-3 | | | | | |
| | toner) | | | | | | | | |
| Example9 | A9 | St/Ac | 9.2 | Pyrazolotriazole- | 1,000 | B1 | Pes | 10.6 | CR-60-2 |
| | (Magenta | | | based dye I-3 | | | | | |
| | toner) | | | | | | | | |
| Example10 | A10 | Pes | 10.4 | Pyrazolotriazole- | 30 | B10 | St/Ac | 9.3 | CR-60-2 |
| | (Magenta | | | based dye I-3 | | | | | |
| | toner) | | | | | | | | |
| Comparative | A1 | St/Ac | 9.2 | Pyrazolotriazole- | 30 | B10 | St/Ac | 9.2 | CR-60-2 |
| Example1 | (Magenta | | | based dye I-3 | | | | | |
| | toner) | | | | | | | | |
| Comparative | A10 | St/Ac + | 9.7 | Pyrazolotriazole- | 30 | B2 | Pes + | 9.9 | CR-60-2 |
| Example2 | (Magenta | Pes | | based dye I-3 | | | St/Ac | | |
| | toner) | | | | | | | | |

| | | Absolute value (ΔSP | | |
|---|---|---|---|---|
| | | value) of difference | Property of suppressing | |
| | White toner B | in solubility | fading in high- | |
| | Method of producing | parameter between | temperature and high- | Halftone |
| | white toner B | resin A and resin B | humidity environment | reproducibility |
| Example1 | Emulsion aggregation | 1.4 | AA | A |
| | and coalescence | | | |
| | method | | | |
| Example2 | Emulsion aggregation | 0.5 | B | A |
| | and coalescence | | | |
| | method | | | |
| Example3 | Emulsion aggregation | 3 | A | B(deviation of dots) |
| | and coalescence | | | |
| | method | | | |
| Example4 | Emulsion aggregation | 4 | AA | C(deviation of dots) |
| | and coalescence | | | |
| | method | | | |
| Example5 | Emulsion aggregation | 1.4 | B | A |
| | and coalescence | | | |
| | method | | | |
| Example6 | Emulsion aggregation | 1.4 | A | A |
| | and coalescence | | | |
| | method | | | |
| Example7 | Emulsion aggregation | 1.2 | A | A |
| | and coalescence | | | |
| | method | | | |
| Example8 | Emulsion aggregation | 1.4 | A | A |
| | and coalescence | | | |
| | method | | | |
| Example9 | Emulsion aggregation | 1.4 | A | B(decrease in |
| | and coalescence | | | saturation |
| | method | | | of toner A) |
| Example10 | Emulsion aggregation | 1.1 | B | B(decrease in |
| | and coalescence | | | whiteness |
| | method | | | of toner B) |
| Comparative | Emulsion aggregation | 0 | D | A |
| Example1 | and coalescence | | | |
| | method | | | |
| Comparative | Emulsion aggregation | 0.2 | C | A |
| Example2 | and coalescence | | | |
| | method | | | |

Further, St/Ac in Table 2 denotes a styrene acrylic resin, and Pes denotes a polyester resin.

As shown in the above-described results, it is found that an image with an excellent property of suppressing fading in a high-temperature and high-humidity environment can be obtained as compared with the comparative examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing toner set comprising:
a toner A that contains a binder resin A and a dye; and
a white toner B that contains a binder resin B and a titanium oxide pigment,
wherein an absolute value of a difference (ΔSP value) in solubility parameter between the binder resin A contained in the toner A and the binder resin B contained in the white toner B is 0.5 or greater.

2. An electrostatic charge image developing toner set comprising:
a toner A that contains a binder resin A and a dye; and
a white toner B that contains a binder resin B and a titanium oxide pigment,
wherein one of the binder resin A contained in the toner A or the binder resin B contained in the white toner B includes a styrene acrylic resin, and the other includes a polyester resin.

3. The electrostatic charge image developing toner set according to claim 1,
wherein the binder resin A is a styrene acrylic resin, and the binder resin B is a polyester resin.

4. The electrostatic charge image developing toner set according to claim 1,
wherein the dye includes at least any one or more of a pyrazolotriazole-based dye or a phthalocyanine-based dye.

5. The electrostatic charge image developing toner set according to claim 1,
wherein the dye contains a pyrazolotriazole-based compound represented by Formula (I), 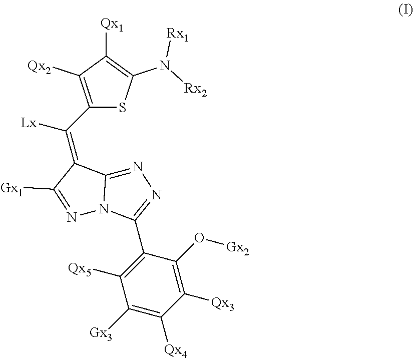
in Formula (I), Rx₁ and Rx₂ each independently represent an alkyl group that may have a substituent, Lx represents a hydrogen atom or an alkyl group that may have a substituent, Gx₁ represents an alkyl group having 2 or more carbon atoms, Gx₂ represents an aryl group or an alkyl group that may have a substituent, Gx₃ represents a hydrogen atom, a halogen atom, Gx₄—CO—NH—, or Gx₅—N(Gx₆)—CO—, Gx₄ represents an aryl group or an alkyl group that may have a substituent, Gx₅ and Gx₆ each independent represent a hydrogen atom or an alkyl group that may have a substituent, and Qx₁ to Qx₅ each independently represent a hydrogen atom, a halogen atom, or an alkyl group that may have a substituent.

6. The electrostatic charge image developing toner set according to claim 1,
wherein the dye contains a phthalocyanine-based compound represented by Formula (II), 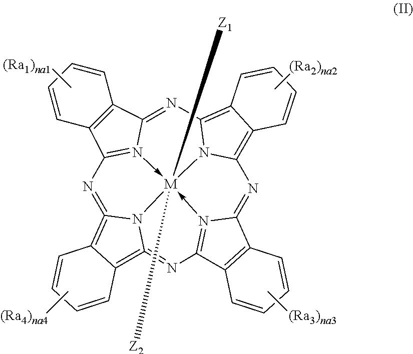
in Formula (II), M represents a silicon atom, a germanium atom, or a tin atom, Ra₁ to Ra₄ each independently represent an electron-withdrawing group, na1 to na4 each independently represent an integer of 0 to 4, and Z₁ and Z₂ each independently represent a hydroxy group, an aryloxy group having 6 to 18 carbon atoms, an alkoxy group having 1 to 22 carbon atoms, or a group represented by Formula (III), 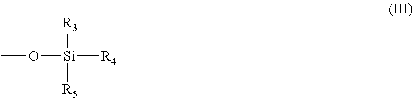
in Formula (III), R₃ to R₅ each independently represent an alkyl group having 1 to 6 carbon atoms, an aryl group having 6 to 18 carbon atoms, or an alkoxy group having 1 to 6 carbon atoms.

7. The electrostatic charge image developing toner set according to claim 1,
wherein a content of the binder resin A is 51% by mass or greater with respect to a total mass of a binder resin contained in the toner A, and
a content of the binder resin B is 51% by mass or greater with respect to a total mass of a binder resin contained in the white toner B.

8. The electrostatic charge image developing toner set according to claim 1,
wherein the absolute value of the difference (ΔSP value) in solubility parameter between the binder resin A and the binder resin B is 0.5 or greater and 3.0 or less.

9. The electrostatic charge image developing toner set according to claim 8,
wherein the absolute value of the difference (ΔSP value) in solubility parameter between the binder resin A and the binder resin B is 1.0 or greater and 3.0 or less.

10. The electrostatic charge image developing toner set according to claim 1,
wherein at least a part of the dye is dispersed in the toner in a particle form.

11. The electrostatic charge image developing toner set according to claim 10,
wherein the dyes in the particle form among the dyes have a number average particle diameter 10 nm or greater and 1000 nm or less.

12. An electrostatic charge image developer set comprising:
a first electrostatic charge image developer that contains the toner A of the electrostatic charge image developing toner set according to claim 1; and
a second electrostatic charge image developer that contains the white toner B of the electrostatic charge image developing toner set according to claim 1.

13. A toner cartridge set that is detachable from an image forming device, comprising:
a first toner cartridge that includes a container accommodating the toner A of the electrostatic charge image developing toner set according to claim 1; and
a second toner cartridge that includes a container accommodating the white toner B of the electrostatic charge image developing toner set according to claim 1.
